(19) United States
(12) Patent Application Publication
(10) Pub. No.: US 2026/0244249 A1
(43) Pub. Date: Aug. 20, 2026

(54) FOLDABLE ELECTRONIC DEVICE INCLUDING HINGE ASSEMBLY

(71) Applicant: Samsung Electronics Co., Ltd., Suwon-si (KR)

(72) Inventors: Dongik LEE, Suwon-si (KR); Sunggun CHO, Suwon-si (KR); Myungchul RYU, Suwon-si (KR); Yeongmin PARK, Suwon-si (KR); Iksu JUNG, Suwon-si (KR)

(21) Appl. No.: 19/647,223

(22) Filed: Apr. 14, 2026

Related U.S. Application Data
(63) Continuation of application No. PCT/KR2024/014673, filed on Sep. 26, 2024.

(30) Foreign Application Priority Data
Nov. 20, 2023 (KR) 10-2023-0161421
Nov. 27, 2023 (KR) 10-2023-0167036

(51) Int. Cl. G06F 1/16

(52) U.S. Cl. CPC G06F 1/1681; G06F 1/1601; G06F 1/1616

(57) ABSTRACT

A foldable electronic device is provided. The foldable electronic device includes a first housing, a second housing, and a hinge assembly rotatably connecting the first housing and the second housing, the hinge assembly including a first rotator including a first gear configured to rotate about a first axis, connecting to the first housing, a second rotator body, including a second gear configured to rotate about a second axis parallel to the first axis, connecting to the second housing, a first rack gear engaged with the first gear, a second rack gear engaged with the second gear, an elastic member, disposed between the first rack gear and the second rack gear, configured to press the first rack gear and the second rack gear in a direction toward the first gear and the second gear, respectively, and a guide guiding movement of the first rack gear and the second rack gear in accordance with a rotation of the first gear and the second gear.

### CROSS-REFERENCE TO RELATED APPLICATION(S)

This application is a continuation application, claiming priority under 35 U.S.C. § 365(c), of an International application No. PCT/KR2024/014673, filed on Sep. 26, 2024, which is based on and claims the benefit of a Korean patent application number 10-2023-0161421, filed on Nov. 20, 2023, in the Ministry of Intellectual Property (MOIP), and of a Korean patent application number 10-2023-0167036, filed on Nov. 27, 2023, in the Ministry of Intellectual Property (MOIP), the disclosure of each of which is incorporated by reference herein in its entirety.

### BACKGROUND

### 1. Field

The disclosure relates to a foldable electronic device including a hinge assembly.

### 2. Description of Related Art

A foldable electronic device may have a folded state or an unfolded state. While the foldable electronic device changes between the folded state and the unfolded state, respective housings of the foldable electronic device may rotate about a folding axis in conjunction with each other.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a foldable electronic device including a hinge assembly.

Additional aspects will be set forth in part in the description which follows and, in part, will be apparent from the description, or may be learned by practice of the presented embodiments.

In accordance with an aspect of the disclosure, a foldable electronic device is provided. The foldable electronic device includes a first housing, a second housing, and a hinge assembly rotatably connecting the first housing and the second housing, the hinge assembly including a first rotator, including a first gear configured to rotate about a first axis, connecting to the first housing, a second rotator, including a second gear configured to rotate about a second axis parallel to the first axis, connecting to the second housing, a first rack gear engaged with the first gear, a second rack gear, engaged with the second gear, an elastic member, disposed between the first rack gear and the second rack gear, configured to press the first rack gear and the second rack gear in a direction toward the first gear and the second gear, respectively, and a guide guiding movement of the first rack gear and the second rack gear in accordance with a rotation of the first gear and the second gear.

In accordance with another aspect of the disclosure, a foldable electronic device is provided. The foldable electronic device includes a first housing part, a second housing part, and a hinge assembly rotatably connecting the first housing part and the second housing part, the hinge assembly including a first rotator, including a first gear configured to rotate about a first axis, connecting to the first housing part, a second rotator, including a second gear configured to rotate about a second axis parallel to the first axis, connecting to the second housing part, a first rack gear engaged with the first gear, a second rack gear engaged with the second gear, and an elastic member, disposed between the first rack gear and the second rack gear closely contacting the first gear and the first rack gear, and configured to maintain an angle between the first housing part and the second housing part by closely contacting the second gear and the second rack gear, wherein the first rack gear and the second rack gear are configured to linearly move by a rotation of the first gear and the second gear.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates an unfolded state of a foldable electronic device according to an embodiment of the disclosure;

FIG. 1B illustrates a folded state of a foldable electronic device according to an embodiment of the disclosure;

FIG. 1C is an exploded view of a foldable electronic device according to an embodiment of the disclosure;

FIG. 2 is an exploded view of housings and a hinge assembly of a foldable electronic device according to an embodiment of the disclosure;

FIG. 3A is a cross-sectional view of a foldable electronic device in an unfolded state according to an embodiment of the disclosure;

FIG. 3B is a cross-sectional view of a foldable electronic device in a folded state according to an embodiment of the disclosure;

FIG. 4 is a plan view illustrating a hinge assembly according to an embodiment of the disclosure;

FIG. 5 is an exploded view of a hinge assembly according to an embodiment of the disclosure;

FIG. 6 is a drawing illustrating a coupling relationship between rotators and rack gears of a hinge assembly according to an embodiment of the disclosure;

FIG. 7 is an exploded perspective view illustrating rotators and rack gears of the hinge assembly according to an embodiment of the disclosure;

FIG. 8 is a drawing illustrating a guide structure of a hinge assembly according to an embodiment of the disclosure;

FIGS. 9A and 9B are drawings illustrating a hinge assembly including a dumbbell-shaped guide structure according to various embodiments of the disclosure;

FIG. 10A is a drawing illustrating an unfolded state of a hinge assembly according to an embodiment of the disclosure;

FIG. 10B is a drawing illustrating a closed state of a hinge assembly according to an embodiment of the disclosure;

FIG. 11 illustrates a structure of a stopper for limiting movement in a closed state of a hinge assembly according to an embodiment of the disclosure;

FIG. 12 is a plan view illustrating a hinge assembly including a plate assembled to rack gears according to an embodiment of the disclosure;

FIG. 13A is a cross-sectional view of a foldable electronic device in an unfolded state by a hinge assembly including a plate assembled to rack gears according to an embodiment of the disclosure;

FIG. 13B is a cross-sectional view of a foldable electronic device in a closed state by a hinge assembly including a plate assembled to rack gears according to an embodiment of the disclosure; and

FIG. 14 is a block diagram of an electronic device in a network environment according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

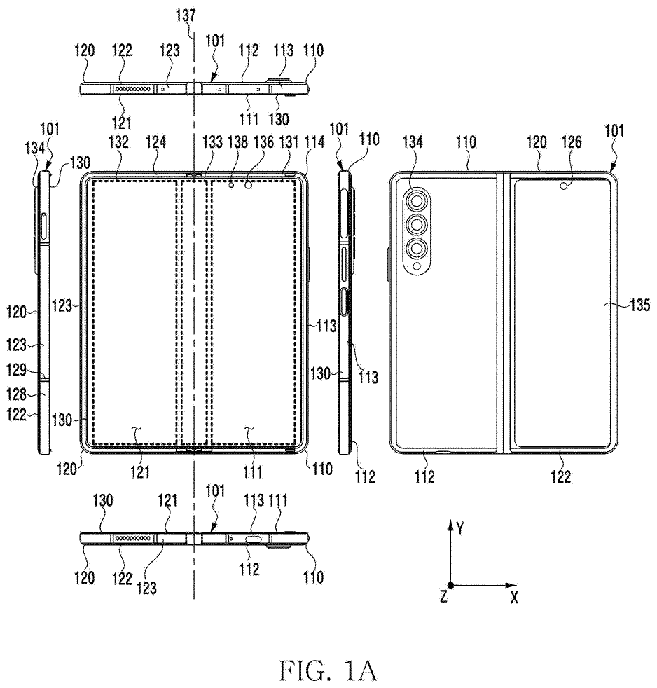

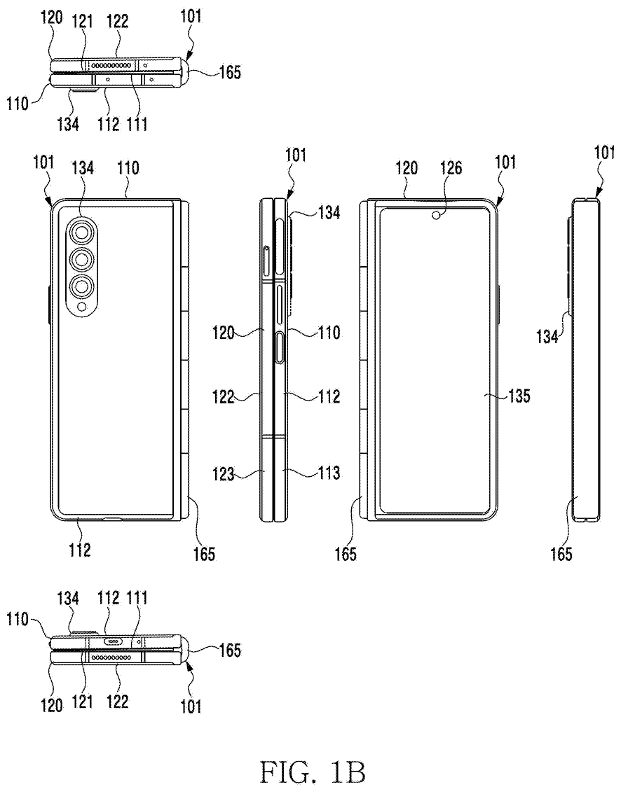

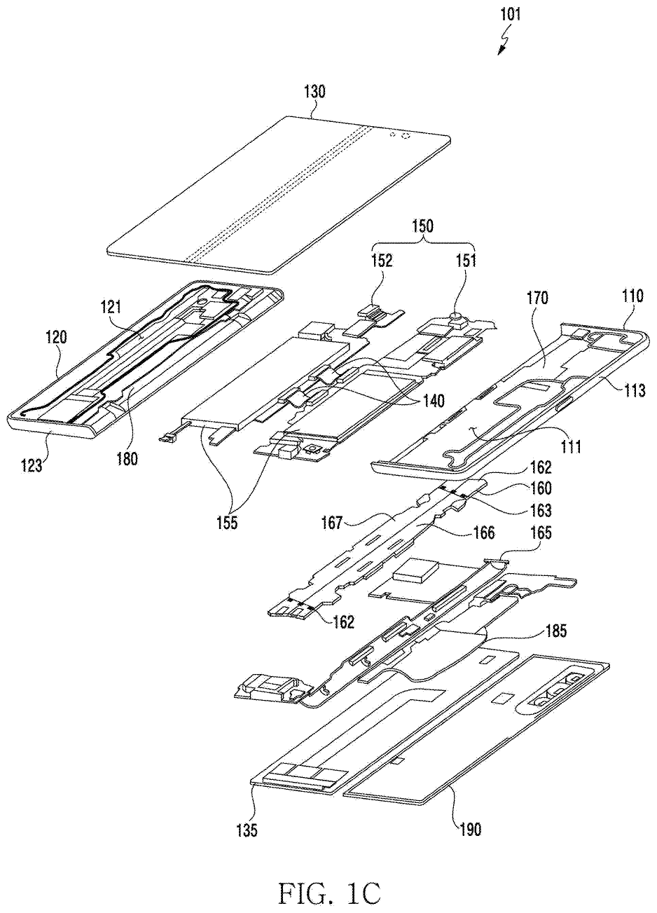

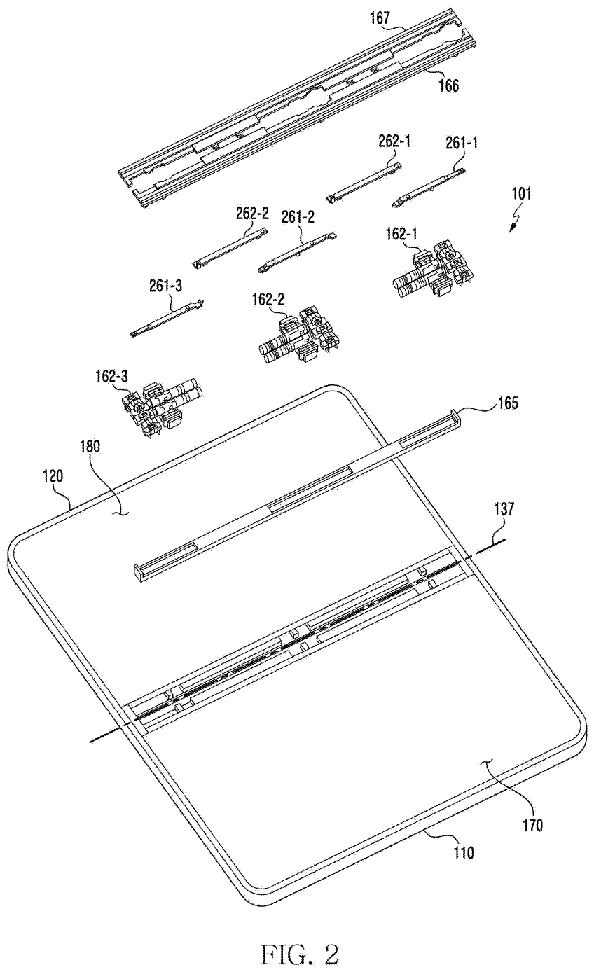

FIG. 1A illustrates an unfolded state of an electronic device according to an embodiment of the disclosure. FIG. 1B illustrates a folded state of the electronic device according to an embodiment of the disclosure. FIG. 1C is an exploded view of a foldable electronic device according to an embodiment of the disclosure. FIG. 2 is an exploded view of housings and a hinge assembly of a foldable electronic device according to an embodiment of the disclosure.

Referring to FIGS. 1A to 1C, an electronic device 101 may include a first housing 110, a second housing 120, and a flexible display 130. The electronic device 101 may be a device in which the first housing 110 and the second housing 120 may contact each other. The electronic device 101 may be referred to as a foldable electronic device.

In an embodiment of the disclosure, the first housing 110 may include a first surface 111, a second surface 112 spaced apart from the first surface 111, and a first lateral side 113 surrounding at least a portion of the first surface 111 and the second surface 112. In an embodiment of the disclosure, the electronic device 101 may further include at least one camera 134 exposed through a portion of the second surface 112.

In an embodiment of the disclosure, the second housing 120 may include a third surface 121, a fourth surface 122 facing and spaced apart from the third surface 121, and a second lateral side 123 surrounding at least a portion of the third surface 121 and the fourth surface 122. The electronic device 101 may further include a display panel 135 disposed on a second support member 180. At least a portion of the fourth surface 122 of the second housing 120 may be formed by the display panel 135. The electronic device 101 may further include a camera 126. The camera 126 may be disposed inside the second housing 120 to face the fourth surface 122 so as to obtain an external image through the fourth surface 122. The camera 126 may be an under display camera (UDC) disposed under the display panel 135, covered by the display panel 135, and configured to obtain an external image through light transmitted through the display panel 135. In an embodiment of the disclosure, the camera 126 may be disposed under the display panel 135, and the display panel 135 may include an opening aligned with a lens of the camera 126 to transmit light from the outside to the camera 126.

According to an embodiment of the disclosure, each of the first housing 110 and the second housing 120 may include a first protective member 114 and a second protective member 124, respectively. The first protective member 114 and the second protective member 124 may be disposed on the first surface 111 and the third surface 121 along a periphery of the flexible display 130. The first protective member 114 and the second protective member 124 may prevent or reduce inflow of foreign substances (e.g., dust or moisture) through a gap between the flexible display 130 and the first housing 110 and the second housing 120. The first protective member 114 may be disposed along a periphery of a first display area 131, and the second protective member 124 may be disposed along a periphery of a second display area 132. The first protective member 114 may be formed by being attached to the first lateral side 113 of the first housing 110 or may be integrally formed with the first lateral side 113. The second protective member 124 may be formed by being attached to the second lateral side 123 of the second housing 120 or may be integrally formed with the second lateral side 123.

In an embodiment of the disclosure, the first housing 110 may provide a space formed by the first surface 111, the second surface 112, and the first lateral side 113 as a space for disposing components of the electronic device 101. The second housing 120 may provide a space formed by the third surface 121, the fourth surface 122, and the second lateral side 123 as a space for disposing components of the electronic device 101.

In an embodiment of the disclosure, the first lateral side 113 and the second lateral side 123 may include a conductive material, a non-conductive material, or a combination thereof. For example, the second lateral side 123 may include a conductive member 128 and a non-conductive member 129. The conductive member 128 may include a plurality of conductive members and may be spaced apart from each other. The non-conductive member 129 may be disposed between the plurality of conductive members. An antenna structure may be formed by the plurality of conductive members and a portion of a plurality of non-conductive members, or a combination thereof.

In an embodiment of the disclosure, the second lateral side 123 may be rotatably (or pivotably) connected to the first lateral side 113 through a hinge structure 160 disposed on a hinge cover 165. The hinge structure 160 may include a hinge assembly 162, a first hinge plate 166, and a second hinge plate 167. The first hinge plate 166 may be connected to the first housing 110, and the second hinge plate 167 may be connected to the second housing 120.

In an embodiment of the disclosure, the flexible display 130 may include a window exposed toward the outside. The window may protect a surface of the flexible display 130, may be formed as a protective layer, and may transmit visual information provided from the flexible display 130 to the outside. The window may include a glass material, such as ultra-thin glass (UTG) or a polymer material, such as polyimide (PI). In an embodiment of the disclosure, the flexible display 130 may form the first surface 111 of the first housing 110 and the third surface 121 of the second housing 120 across the hinge structure 160. The flexible display 130 may be disposed on a first support member 170 and the second support member 180. The flexible display 130 may include the first display area 131 disposed on the first support member 170, the second display area 132 disposed on the second support member 180, and a third display area 133 between the first display area 131 and the second display area 132. The first display area 131, the second display area 132, and the third display area 133 may form a front surface of the flexible display 130.

According to an embodiment of the disclosure, an opening may be formed in a portion of a screen display area of the flexible display 130, or a recess or an opening may be formed in a support member (e.g., a bracket) supporting the flexible display 130. The electronic device 101 may include at least one of a sensor module 138 aligned with the recess or the opening and a camera 136. For example, the first display area 131 may further include the camera 136 capable of obtaining an image from the outside through a portion of the first display area 131, and the sensor module 138 configured to generate an electrical signal or a data value corresponding to an external environmental state. According to an embodiment of the disclosure, at least one of the sensor module 138 and the camera 136 may be included on a rear surface of the flexible display 130 corresponding to the first display area 131 or the second display area 132 of the flexible display 130. For example, at least one of the camera 136 and the sensor module 138 may be disposed below the flexible display 130 and may be surrounded by the flexible display 130. At least one of the camera 136 and the sensor module 138 may be surrounded by the flexible display 130 and may not be exposed to the outside. However, it is not limited thereto, and the flexible display 130 may include an opening that exposes the camera 136 and the sensor module 138 to the outside. Although not illustrated in FIGS. 1A and 1B, in an embodiment of the disclosure, the flexible display 130 may further include a rear surface opposite to the front surface. In an embodiment of the disclosure, the flexible display 130 may be supported by the first support member 170 and the second support member 180.

In an embodiment of the disclosure, the hinge structure 160 may be configured to rotatably connect the first support member 170 forming a portion of the first housing 110 and the second support member 180 forming a portion of the second housing 120. The first support member 170 may be connected to or supported by the first hinge plate 166. The second support member 180 may be connected to or supported by the second hinge plate 167.

In an embodiment of the disclosure, the hinge cover 165 surrounding the hinge structure 160 may be at least partially exposed through a space between the first housing 110 and the second housing 120 while the electronic device 101 is in a folded state. The hinge cover 165 may be covered by the first housing 110 and the second housing 120 while the electronic device 101 is in an unfolded state.

In an embodiment of the disclosure, the electronic device 101 may be folded about a folding axis 137 passing through the hinge cover 165 (or the hinge structure 160). For example, the hinge cover 165 may be disposed between the first housing 110 and the second housing 120 of the electronic device 101 to allow the electronic device 101 to be bent, curved, or folded. For example, the first housing 110 may be connected to the second housing 120 through the hinge structure 160 disposed on the hinge cover 165 and may rotate about the folding axis 137. For example, the hinge structure 160 may include hinge assemblies 162 disposed at both ends of the first hinge plate 166 and the second hinge plate 167. Each hinge assembly 162 may include hinge gears engaged with each other therein, thereby enabling the first hinge plate 166 and the second hinge plate 167 to rotate about the folding axis. The first housing 110 coupled to the first hinge plate 166 may be connected to the second housing 120 coupled to the second hinge plate 167 and may rotate about the folding axis by the hinge assemblies 162.

In an embodiment of the disclosure, the electronic device 101 may be folded such that the first housing 110 and the second housing 120 face each other by rotating about the folding axis 137. In an embodiment of the disclosure, the electronic device 101 may be folded such that the first housing 110 and the second housing 120 overlap or superimpose on each other.

Referring to FIG. 1C, the electronic device 101 may include the first support member 170, the second support member 180, the hinge structure 160, the flexible display 130, a printed circuit board 150, a battery 155, the hinge cover 165, an antenna 185, the display panel 135, and a rear plate 190. According to an embodiment of the disclosure, the electronic device 101 may omit at least one of the components or may additionally include another component.

The first housing 110 and the second housing 120 may support a flexible display (e.g., the flexible display 130 of FIG. 1A). The flexible display panel may include a front surface that provides information by emitting light and a rear surface facing the front surface. When the first surface 111 of the first housing 110 faces the third surface 121 of the second housing 120, the flexible display 130 may be in a folded state in which a surface faced by the first display area 131 and a surface faced by the second display area 132 of the flexible display 130 face each other. When the first surface 111 of the first housing 110 and the third surface 121 of the second housing 120 face the same direction, the flexible display 130 may be in an unfolded state in which the first display area 131 and the second display area 132 of the flexible display 130 face the same direction.

In an embodiment of the disclosure, the electronic device 101 may provide an unfolded state in which the first housing 110 and the second housing 120 are fully folded out by the hinge structure 160. The first support member 170 may be connected to the second support member 180 through the hinge structure 160 to switch the electronic device 101 to a folded state or an unfolded state. By a rotation of a hinge gear 163, the first support member 170 and the second support member 180 attached to the hinge plates 166 and 167 of the hinge structure 160 may move. The hinge plates 166 and 167 may include the first hinge plate 166 coupled to the first support member 170 and the second hinge plate 167 coupled to the second support member 180. The electronic device 101 may be switched to the folded state or the unfolded state by the rotation of the hinge gear 163.

The hinge structure 160 may include the hinge assembly 162, the first hinge plate 166, and the second hinge plate 167. The hinge assembly 162 may include the hinge gear 163 that makes the first hinge plate 166 and the second hinge plate 167 pivotable. The hinge gear 163 may rotate while being engaged with each other, and thus may rotate the first hinge plate 166 and the second hinge plate 167. The hinge assembly 162 may be a plurality of hinge assemblies. Each of the plurality of hinge assemblies may be disposed on both sides formed by the first hinge plate 166 and the second hinge plate 167.

The first hinge plate 166 may be coupled to the first support member 170 of the first housing 110, and the second hinge plate 167 may be coupled to the second support member 180 of the second housing 120. The first housing 110 and the second housing 120 may rotate to correspond to a rotation of the first hinge plate 166 and the second hinge plate 167.

The first housing 110 may include the first support member 170 and the second support member 180. The first support member 170 may be partially surrounded by the first lateral side 113, and the second support member 180 may be partially surrounded by the second lateral side 123. The first support member 170 may be integrally formed with the first lateral side 113, and the second support member 180 may be integrally formed with the second lateral side 123. According to an embodiment of the disclosure, the first support member 170 may be formed separately from the first lateral side 113, and the second support member 180 may be formed separately from the second lateral side 123. The first lateral side 113 and the second lateral side 123 may be formed of a metal material, a non-metal material, or a combination thereof and may be used as an antenna.

The first support member 170 may be coupled to the flexible display 130 on a surface and may be coupled to the rear plate 190 on another surface. The second support member 180 may be coupled to the flexible display 130 on a surface and may be coupled to the display panel 135 on another surface.

The printed circuit board 150 and the battery 155 may be disposed between a surface formed by the first support member 170 and the second support member 180 and a surface formed by the display panel 135 and the rear plate 190. The printed circuit board 150 may be separated so as to be disposed in the first support member 170 of the first housing 110 and the second support member 180 of the second housing 120, respectively. A shape of a first printed circuit board 151 disposed on the first support member 170 and a shape of a second printed circuit board 152 disposed on the second support member 180 may be different from each other according to an internal space of the electronic device. The first printed circuit board 151 and the second printed circuit board 152 may have components disposed to implement various functions of the electronic device 101. According to an embodiment of the disclosure, on the first printed circuit board 151, components for implementing overall functions of the electronic device 101 may be disposed, and on the second printed circuit board 152, electronic components for implementing some functions of the first printed circuit board 151 may be disposed, or components for driving the display panel 135 disposed on the fourth surface 122 may be disposed. The first printed circuit board 151 and the second printed circuit board 152 may be electrically connected by a flexible printed circuit board 140.

The battery 155 may be, for example, a device for supplying power to at least one component of the electronic device 101, and may include, for example, a non-rechargeable primary cell, a rechargeable secondary cell, or a fuel cell. At least a portion of the battery 155 may be disposed on substantially the same plane as the printed circuit board 150. A surface formed by the substantially same plane of the printed circuit board 150 and the battery 155 may be disposed on a surface of the first support member 170 and the second support member 180 (e.g., a surface facing the second surface 112 and the fourth surface 122 or a surface facing the display panel 135 and the rear plate 190). For example, the flexible display 130 may be disposed on the first surface 111 and the third surface 121, and the printed circuit board 150 and the battery 155 may be disposed on the second surface 112 and the fourth surface 122 facing the surface on which the flexible display 130 is disposed.

In an embodiment of the disclosure, the antenna 185 may be disposed between the rear plate 190 and the battery 155. The antenna 185 may include, for example, a near field communication (NFC) antenna, a wireless charging antenna, and/or a magnetic secure transmission (MST) antenna. The antenna 185 may, for example, perform short-range communication with an external device or wirelessly transmit and receive power for charging.

Referring to FIG. 2, a hinge structure 160 may include a hinge assembly 162, a hinge cover 165, a first hinge plate 166, a second hinge plate 167, and bar-shaped plates 261-1, 261-2, 261-3, 262-1, and 262-2. The hinge structure 160 may pivotably connect a first housing 110 (or a first support member 170 of the first housing 110) and a second housing 120 (or a second support member 180 of the second housing 120). The hinge assembly 162 may pivotably connect the first housing 110 and the second housing 120. The hinge assembly 162 may be coupled to the first housing 110 (or the first support member 170 of the first housing 110) on a right side about a folding axis 137. The hinge assembly 162 may be coupled to the second housing 120 (or the second support member 180 of the second housing 120) on a left side about the folding axis 137. When an electronic device 101 is folded about the folding axis 137, the first support member 170 and the second support member 180 connected to the hinge assembly 162 may rotate about the folding axis 137.

The hinge assembly 162 may be connected to the first hinge plate 166 and the second hinge plate 167. The hinge assembly 162 may be coupled to the first hinge plate 166 on the right side about the folding axis 137. The hinge assembly 162 may be coupled to the second hinge plate 167 on the left side with respect to the folding axis 137. The first hinge plate 166 may be connected to the first housing 110 (or the first support member 170). The second hinge plate 167 may be connected to the second housing 120 (or the second support member 180). When the electronic device 101 is folded about the folding axis 137, the first hinge plate 166 and the second hinge plate 167 connected to the hinge assembly 162 may rotate about the folding axis 137. In accordance with the rotation of the first hinge plate 166 and the second hinge plate 167, the first housing 110 (or the first support member 170) and the second housing 120 (or the second support member 180) may rotate about the folding axis 137.

The first hinge plate 166 and the second hinge plate 167 may be spaced apart from each other. The first hinge plate 166 and the second hinge plate 167 may be line-symmetrical about the folding axis 137. The hinge structure 160 may have a space between the first hinge plate 166 and the second hinge plate 167 due to spacing between the first hinge plate 166 and the second hinge plate 167.

A flexible display 130 may be supported by the first hinge plate 166, the second hinge plate 167, the first support member 170, and the second support member 180. To fill the space between the first hinge plate 166 and the second hinge plate 167, the bar-shaped plates 261-1, 261-2, 261-3, 262-1, and 262-2 may be included. The bar-shaped plates 261-1, 261-2, 261-3, 262-1, and 262-2 may be disposed between the first hinge plate 166 and the second hinge plate 167. The bar-shaped plates 261-1, 261-2, 261-3, 262-1, and 262-2 may support the flexible display 130 by filling the space between the first hinge plate 166 and the second hinge plate 167. The bar-shaped plates 261-1, 261-2, 261-3, 262-1, and 262-2 may reduce damage to the flexible display 130 by limiting the flexible display 130 from directly contacting a hinge gear or directly contacting a connecting member (e.g., a screw). Some plates 261-1, 261-2, and 261-3 among the bar-shaped plates 261-1, 261-2, and 261-3 may be assembled to hinge assemblies 162-1, 162-2, and 162-3.

The number of the some plates 261-1, 261-2, and 261-3 may correspond to the number of the hinge assemblies 162-1, 162-2, and 162-3. The hinge assemblies 162-1, 162-2, and 162-3 may include a first hinge assembly 162-1, a second hinge assembly 162-2, and a third hinge assembly 162-3. The first hinge assembly 162-1 may be disposed on an upper side of the folding axis 137 with reference to the drawing, and the third hinge assembly 162-3 may be disposed on a lower side of the folding axis 137. The second hinge assembly 162-2 may be disposed between the first hinge assembly 162-1 and the third hinge assembly 162-3. The first hinge assembly 162-1, the second hinge assembly 162-2, and the third hinge assembly 162-3 may be spaced apart from each other and may be disposed along the folding axis 137. Although three hinge assemblies have been described, it is not limited thereto. The hinge structure 160 may include two hinge assemblies by omitting the second hinge assembly 162-2, or may include three or more hinge assemblies by further including hinge assemblies.

The first plate 261-1 may be coupled to the first hinge assembly 162-1. The second plate 261-2 may be coupled to the second hinge assembly 162-2. The third plate 261-3 may be coupled to the third hinge assembly 162-3. Each of the first plate 261-1, the second plate 261-2, and the third plate 261-3 may be disposed at a center of the first hinge assembly 162-1, the second hinge assembly 162-2, and the third hinge assembly 162-3, respectively. For example, each of the first plate 261-1, the second plate 261-2, and the third plate 261-3 may be disposed on the first hinge assembly 162-1, the second hinge assembly 162-2, and the third hinge assembly 162-3 along the folding axis 137, respectively. The first plate 261-1, the second plate 261-2, and the third plate 261-3 may be referred to as center bars in terms of being formed in a bar shape and being disposed at the center of the hinge assembly 162. The first plate 261-1, the second plate 261-2, and the third plate 261-3 may be spaced apart from the flexible display 130. The first plate 261-1, the second plate 261-2, and the third plate 261-3 may move toward the hinge cover 165 so as to be spaced apart from a bending portion (e.g., a portion corresponding to a third display area 133) of the flexible display 130 while the electronic device 101 changes to a folded state. The first plate 261-1, the second plate 261-2, and the third plate 261-3 may move in a direction toward the hinge plates 166 and 167 (or in a direction toward the bending portion of the flexible display 130) so as to maintain a distance from the bending portion (e.g., the portion corresponding to the third display area 133) of the flexible display 130 while the electronic device 101 changes to an unfolded state.

The fourth plate 262-1 and the fifth plate 262-2 may be disposed in a spaced space between the first plate 261-1, the second plate 261-2, and the third plate 261-3. The fourth plate 262-1 may be disposed between the first plate 261-1 and the second plate 261-2. The fourth plate 262-1 may connect the first plate 261-1 and the second plate 261-2. For example, an end of the fourth plate 262-1 may be disposed on the first plate 261-1, and another end of the fourth plate 262-1 may be disposed on the second plate 261-2. The fifth plate 262-2 may be disposed between the second plate 261-2 and the third plate 261-3. The fifth plate 262-2 may connect the second plate 261-2 and the third plate 261-3. An end of the fifth plate 262-2 may be disposed on the second plate 261-2, and another end of the fifth plate 262-2 may be disposed on the third plate 261-3. The fourth plate 262-1 and the fifth plate 262-2 may be referred to as bridges in terms of connecting the first plate 261-1, the second plate 261-2, and the third plate 261-3.

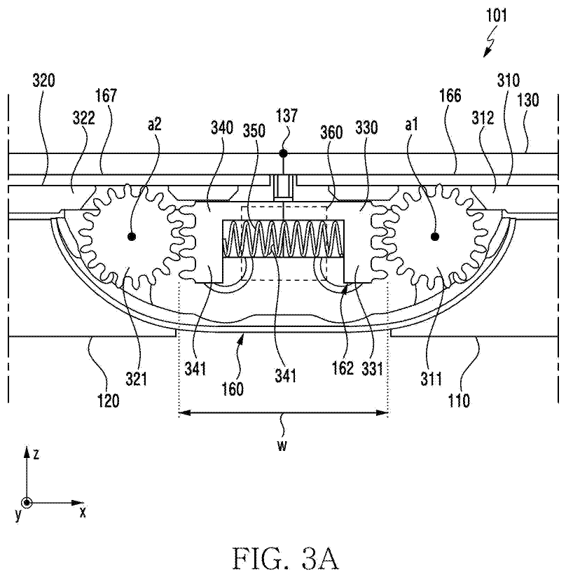

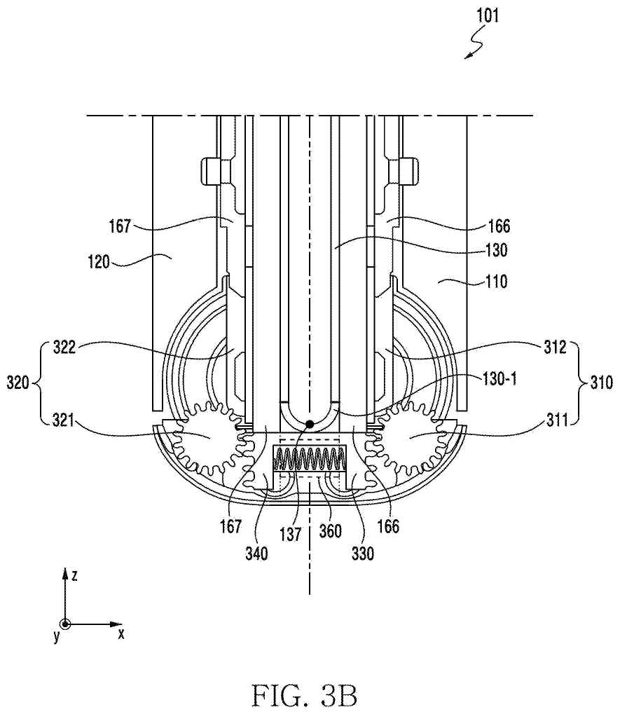

FIG. 3A is a cross-sectional view of a foldable electronic device in an unfolded state according to an embodiment of the disclosure. FIG. 3B is a cross-sectional view of a foldable electronic device in a folded state according to an embodiment of the disclosure.

Referring to FIGS. 3A and 3B, a foldable electronic device 101 may include a first housing 110 and a second housing 120. The first housing 110 may include a first support member 170. The second housing 120 may include a second support member 180. The first housing 110 and the second housing 120 may rotate about a folding axis 137.

The foldable electronic device 101 may include a hinge structure 160. The hinge structure 160 may rotatably couple the first housing 110 and the second housing 120. The first housing 110 may be rotatably coupled to the hinge structure 160 about the folding axis 137. The second housing 120 may be rotatably coupled to the hinge structure 160 about the folding axis 137. For example, the hinge structure 160 may include a hinge assembly 162 and a first hinge plate 166 or a second hinge plate 167. The first hinge plate 166 may connect the hinge assembly 162 and a flexible display 130. The second hinge plate 167 may connect the hinge assembly 162 and the flexible display 130. A portion of the hinge assembly 162 may be coupled to the first support member 170, and a portion of the remaining part of the hinge assembly 162 may be coupled to the second support member 180.

The hinge assembly 162 may include a first rotator 310. The first rotator 310 may rotate about a first axis a1, and the first rotator 310 may be connected to the first housing 110.

The first rotator 310 may include a first gear 311 and a first support portion 312. The first gear 311 may rotate about the first axis a1. The first gear 311 may rotate about a shaft coaxial with the first axis a1. In accordance with the rotation of the first gear 311, the first rotator 310 may rotate about the first axis a1. The first support portion 312 may be connected to the first gear 311 and may rotate together with the first gear 311. The first support portion 312 may be integrally formed with the first gear 311. The first support portion 312 may support the first hinge plate 166 and the first housing 110 (or the first support member 170). The first support portion 312 may contact the first hinge plate 166 or the first housing 110. The first support portion 312 may extend from the first gear 311 in parallel with the first support member 170. The first support portion 312 may extend from the first gear 311 in a direction away from the folding axis 137. The first rotator 310 may include the first support portion 312 that rotates about the first axis a1 and extends from the first axis a1 in a direction perpendicular to the first axis a1. The first rotator 310 may be referred to as an arm in terms of the first support portion 312 rotating about the first axis a1, or may be referred to as a link in terms of connecting the first housing 110 or the first support member 170 while performing a pivot motion about the first axis a1.

A second rotator 320 may include a second gear 321 and a second support portion 322. The second gear 321 may rotate about a second axis a2 parallel to the first axis a1. The second gear 321 may rotate about a shaft coaxial with the second axis a2. In accordance with the rotation of the second gear 321, the second rotator 320 may rotate about the second axis a2. The second support portion 322 may be connected to the second gear 321 and may rotate together with the second gear 321. The second support portion 322 may be integrally formed with the second gear 321. The second support portion 322 may support the second hinge plate 167 and the second housing 120 (or the second support member 180). The second support portion 322 may contact the second hinge plate 167 or the second housing 120. The second support portion 322 may extend from the second gear 321 in parallel with the second support member 180. The second support portion 322 may extend from the second gear 321 in a direction away from the folding axis 137. The second rotator 320 may include the second support portion 322 that rotates about the second axis a2 and extends from the second axis a2 in a direction perpendicular to the second axis a2. The second rotator 320 may be referred to as an arm in terms of the second support portion 322 rotating about the second axis a2, or may be referred to as a link in terms of connecting the second housing 120 or the second support member 180 while performing a pivot motion about the second axis a2.

The first rotator 310 and the second rotator 320 may rotate in conjunction with each other. The first rotator 310 and the second rotator 320 may move while substantially maintaining symmetry about the folding axis 137. By linkage of the first rotator 310 and the second rotator 320 about the folding axis 137, the first housing 110 and the second housing 120 may rotate while maintaining symmetry about the folding axis 137. As the first rotator 310 and the second rotator 320 rotate in conjunction with each other, while a state of the electronic device 101 changes, the flexible display 130 may be folded while maintaining symmetry at a bending portion 130-1.

The hinge assembly 162 may further include a linkage structure for maintaining linkage of the first rotator 310 and the second rotator 320. For example, the hinge assembly 162 may further include a first rack gear 330 and a second rack gear 340. The first rack gear 330 may be engaged with the first gear 311. The second rack gear 340 may be engaged with the second gear 321. The first rack gear 330 may move linearly by a rotation of the first gear 311. The second rack gear 340 may move linearly by a rotation of the second gear 321. The first rack gear 330 and the second rack gear 340 may substantially move together along a z-axis direction. For example, the first rack gear 330 and the second rack gear 340 may move toward the bending portion 130-1 of the flexible display 130 while the electronic device 101 changes to an unfolded state. The first rack gear 330 and the second rack gear 340 may move in a +z-axis direction while the electronic device 101 changes to the unfolded state.

The first rack gear 330 and the second rack gear 340 may be configured to move simultaneously. Gear teeth of the first rack gear 330 may closely contact gear teeth of the first gear 311. Gear teeth of the second rack gear 340 may closely contact gear teeth of the second gear 321. The hinge structure 160 may further include a component configured such that the second rack gear 340 and the second gear 321 are in close contact with each other, thereby causing the first rack gear 330 and the first gear 311 to be in close contact with each other. The hinge structure 160 may further include an elastic member 350. The elastic member 350 may be disposed between the first rack gear 330 and the second rack gear 340. The elastic member 350 may press inner surfaces of the first rack gear 330 and the second rack gear 340. The elastic member 350 may provide an elastic force toward the inner surfaces of the first rack gear 330 and the second rack gear 340. The elastic member 350 may include a material that is compressible and has restoring force, such as a spring, a leaf spring, a disc spring, a sponge, a porous material, or a rubber material. The first rack gear 330 may include a sidewall 331 surrounding a portion of the elastic member 350. The second rack gear 340 may include a sidewall 341 surrounding another portion of the elastic member 350. Gear teeth 332 of the first rack gear 330 may be formed on a portion of the sidewall 331 facing the first gear 311. Gear teeth 342 of the second rack gear 340 may be formed on a portion of the sidewall 341 facing the second gear 321. An end of the elastic member 350 may contact an inner surface of the sidewall 331 facing the first gear 311, and another end of the elastic member 350 may contact an inner surface of the sidewall 341 facing the second gear 321. The elastic member 350 may be configured to press the first rack gear 330 and the second rack gear 340 in a direction toward the first gear 311 and the second gear 321, respectively. As the elastic member 350 presses the sidewall 331, the gear teeth 332 of the first rack gear 330 may closely contact the gear teeth of the first gear 311. As the elastic member 350 presses the sidewall 341, the gear teeth 342 of the second rack gear 340 may closely contact the gear teeth of the second gear 321. The elastic member 350 may maintain an engaged state between the first gear 311 and the first rack gear 330 by pressing the first rack gear 330. The elastic member 350 may maintain an engaged state between the second gear 321 and the second rack gear 340 by pressing the second rack gear 340.

The hinge assembly 162 may further include a guide 360. The guide 360 may be configured to guide movement of the first rack gear 330 and the second rack gear 340 in accordance with a rotation of the first gear 311 and the second gear 321. The first rack gear 330 and the second rack gear 340 may include a structure configured to move along the guide. For example, when the guide 360 is a protrusion extending along the z-axis, the first rack gear 330 and the second rack gear 340 may include guide grooves surrounding the protrusion. As the guide grooves face each other, a space or a hole for accommodating the protrusion may be formed. The first rack gear 330 and the second rack gear 340 may move in the z-axis direction (or a-z-axis direction) along the protrusion.

The first gear 311 and the second gear 321 may be linked to each other by the first rack gear 330 and the second rack gear 340. For example, when the first gear 311 rotates counterclockwise about the first axis a1, the first rack gear 330 engaged with the first gear 311 may move in the −z-axis direction along the guide 360. In accordance with the movement of the first rack gear 330, the second rack gear 340 may be pressed by the elastic member 350 and may move together with the first rack gear 330 along the-z-axis. In accordance with the movement of the second rack gear 340 in the-z-axis direction, the second gear 321 may rotate clockwise about the second axis a2. Although it has been described that the first gear 311 moves first and the first rack gear 330, the second rack gear 340, and the second gear 321 sequentially move, this description is for illustrating a process of power transmission, and substantially, the first gear 311, the first rack gear 330, the second rack gear 340, and the second gear 321 may move together.

In accordance with the linkage of the first gear 311 and the second gear 321, the first rotator 310 and the second rotator 320 may rotate in conjunction with each other. In accordance with the linkage of the first rotator 310 and the second rotator 320, the first hinge plate 166, the first housing 110, and/or the first support member 170 coupled to the first rotator 310, and the second hinge plate 167, the second housing 120, and/or the second support member 180 coupled to the second rotator 320 may rotate in conjunction with each other.

As engagement of gears increases, backlash between the gears may increase. In the above-described hinge structure 160, an engagement point between the first gear 311 and the first rack gear 330 and an engagement point between the second gear 321 and the second rack gear 340 may exist regardless of a width w between the first rack gear 330 and the second rack gear 340. For linkage between the first rack gear 330 and the second rack gear 340, the hinge structure 160 may dispose driven gears. When the width w increases, backlash may increase as the number of driven gears disposed between the first rack gear 330 and the second rack gear 340 increases.

According to the above-described embodiment of the disclosure, as the electronic device 101 includes the hinge structure 160 having a linkage structure, the first housing 110 (or a component of the first housing 110 or a component coupled to the first housing 110) and the second housing 120 (or a component of the second housing 120 or a component coupled to the second housing 120) may move symmetrically with each other. The flexible display 130 disposed on the first housing 110 and the second housing 120 may be symmetrically folded or folded out about the folding axis 137 in accordance with linkage of the first housing 110 and the second housing 120. Damage to the flexible display 130 may be reduced by linkage of the first housing 110 and the second housing 120. The hinge structure 160 may reduce a gap or backlash between gears by close contact between the first gear 311 and the first rack gear 330 and close contact between the second gear 321 and the second rack gear 340.

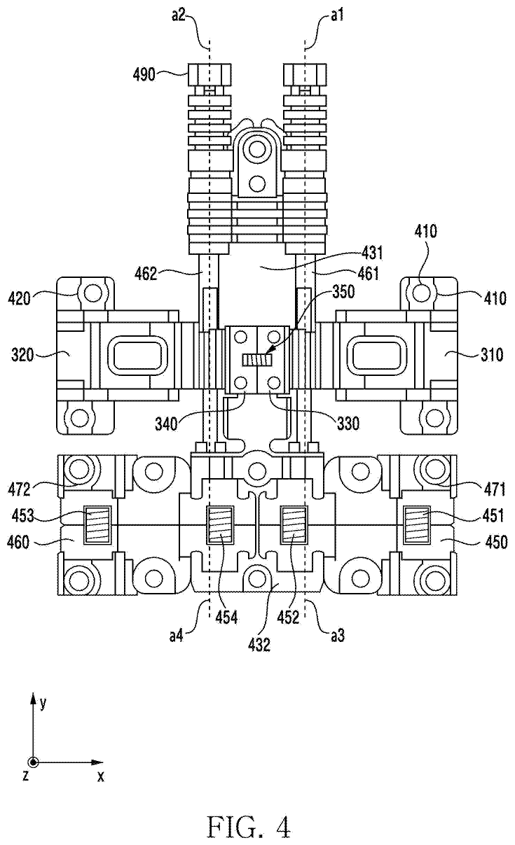

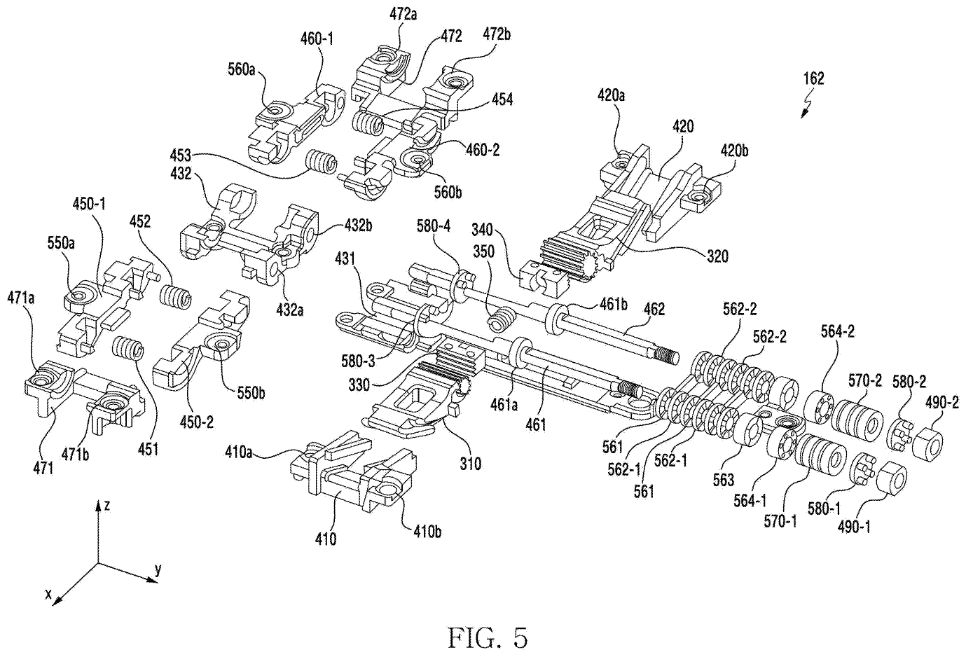

FIG. 4 is a plan view illustrating a hinge assembly according to an embodiment of the disclosure. FIG. 5 is an exploded view of a hinge assembly according to an embodiment of the disclosure.

Referring to FIGS. 4 and 5, a hinge assembly 162 may include a first rotator 310, a second rotator 320, a first rack gear 330, a second rack gear 340, and an elastic member 350. The first rotator 310, the second rotator 320, the first rack gear 330, the second rack gear 340, and the elastic member 350 may be identical or similar to the first rotator 310, the second rotator 320, the first rack gear 330, the second rack gear 340, and the elastic member 350 of FIGS. 3A and 3B. Descriptions overlapping with those of FIGS. 3A and 3B are omitted.

The first rotator 310 may be rotatably coupled to a first shaft 461. The first shaft 461 may provide a first axis (e.g., the first axis a1 of FIG. 3A). The first rotator 310 may rotate about the first shaft 461 coaxial with the first axis a1. The second rotator 320 may be rotatably coupled to a second shaft 462. The second shaft 462 may provide a second axis (e.g., the second axis a2 of FIG. 3A). The second rotator 320 may rotate about the second shaft 462 coaxial with the second axis a2.

The hinge assembly 162 may further include a first frame 431. The first frame 431 may be disposed below the first rack gear 330 and the second rack gear 340. The first frame 431 may be disposed between the first rotator 310 and the second rotator 320, and may be disposed between a first bracket 410 and a second bracket 420. The first frame 431 may include a guide (e.g., the guide 360 of FIGS. 3A and 3B) guiding movement of the first rack gear 330 and the second rack gear 340. The first rack gear 330 and the second rack gear 340 may be movably coupled to the first frame 431 in a linear direction (e.g., a z-axis direction) through the guide 360. The first frame 431 coupled to the first rack gear 330 and the second rack gear 340 may support the first rotator 310 and the second rotator 320. The first frame 431 may support the first bracket 410 coupled to the first rotator 310 and the second bracket 420 coupled to the second rotator 320.

The hinge assembly 162 may further include the first bracket 410 and the second bracket 420. The first bracket 410 may be movably coupled to the first rotator 310. The second bracket 420 may be movably coupled to the second rotator 320. A portion of the first bracket 410 may be inserted into a guide groove formed on a lateral side of the first rotator 310. The first bracket 410 may move along a path of the guide groove of the first rotator 310. While the first rotator 310 rotates about the first shaft 461, the first bracket 410 may rotate about the first shaft 461 while sliding along the guide groove of the first rotator 310. A portion of the second bracket 420 may be inserted into a guide groove formed on a lateral side of the second rotator 320. The second bracket 420 may move along a path of the guide groove of the second rotator 320. While the second rotator 320 rotates about the second shaft 462, the second bracket 420 may rotate about the second shaft 462 while sliding along the guide groove of the second rotator 320.

The first bracket 410 may be connected to a first support member 170 (e.g., the first support member 170 of FIG. 1C). The first bracket 410 may be fastened to the first support member 170 through fastening means and fastening holes 410a and 410b (or grooves). The second bracket 420 may be connected to a second support member 180 (e.g., the second support member 180 of FIG. 1C). The second bracket 420 may be fastened to the second support member 180 through fastening means and fastening holes 420a and 420b (or grooves). The fastening means may include a bolt and/or a nut for screw coupling, a hook structure for hook coupling, or a fitting structure including a groove (or an opening) and a protrusion. Although it has been described that the first bracket 410 (or the second bracket 420) is connected to the first support member 170 (or the second support member 180) through physical coupling, it is not limited thereto. The first bracket 410 (or the second bracket 420) may be coupled to the first support member 170 (or the second support member 180) by bonding (or welding) or by using an adhesive member (tape, adhesive, or double-sided tape).

The hinge assembly 162 may further include a second frame 432, a third rotator 450, and a fourth rotator 460. The second frame 432 may be spaced apart from the first rotator 310 and the second rotator 320. For example, the second frame 432 may be spaced apart from the first rotator 310 and the second rotator 320 in a direction parallel to a folding axis 137. The second frame 432 may be spaced apart from the first rotator 310 and the second rotator 320 in a-y-axis direction. The second frame 432 may be spaced apart from the first frame 431 supporting the first rotator 310 and the second rotator 320, in a folding axis direction.

The second frame 432 may include a first structure 432a into which a portion of the first shaft 461 is inserted and a second structure 432b into which a portion of the second shaft 462 is inserted. The first structure 432a may include a groove or a hole capable of accommodating an end portion of the first shaft 461. The second structure 432b may include a groove or a hole capable of accommodating an end portion of the second shaft 462. The second frame 432 may be coupled to the first shaft 461 through the first structure 432a and may be coupled to the second shaft 462 through the second structure 432b.

The second frame 432 may rotatably support the third rotator 450 and the fourth rotator 460. The third rotator 450 may be rotatably coupled to the second frame 432 about a third axis a3. The fourth rotator 460 may be rotatably coupled to the second frame 432 about a fourth axis a4. The second frame 432 may include a rotation rail for a rotation of the third rotator 450 and the fourth rotator 460. The third rotator 450 may be coupled to a rail configured to rotate about the third axis a3 formed in the second frame 432. The third rotator 450 may rotate about the third axis a3 by moving along the rail. The fourth rotator 460 may be coupled to a rail configured to rotate about the fourth axis a4 formed in the second frame 432. The fourth rotator 460 may rotate about the fourth axis a4 by moving along the rail. The third rotator 450 may be coupled to a third bracket 471. The fourth rotator 460 may be coupled to a fourth bracket 472. The third bracket 471 may be movably coupled to the third rotator 450. The fourth bracket 472 may be movably coupled to the fourth rotator 460. The third bracket 471 (or the fourth bracket 472) may rotate and/or move linearly with respect to the third rotator 450 (or the fourth rotator 460). The third rotator 450 may include a guide rail for motion of the third bracket 471. The fourth rotator 460 may include a guide rail for motion of the fourth bracket 472. The third bracket 471 (or the fourth bracket 472) may move along the guide rail formed in the third rotator 450 (or the fourth rotator 460). A movement path of the third bracket 471 (or the fourth bracket 472) may be determined according to a shape of the guide rail.

The third rotator 450 and the fourth rotator 460 may include a plurality of parts 450-1, 450-2, 460-1, and 460-2 for ease of assembly. The third rotator 450 (or the fourth rotator 460) may include elastic members 451 and 453 for maintaining coupling between the plurality of parts 450-1, 450-2, 460-1, and 460-2 and the third bracket 471 (or the fourth bracket 472), and elastic members 452 and 454 for maintaining coupling between the plurality of parts 450-1, 450-2, 460-1, and 460-2 and the second frame 432. Although it has been described that the third rotator 450 and the fourth rotator 460 are configured with the plurality of parts 450-1, 450-2, 460-1, and 460-2, it is not limited thereto and may be formed as one structure.

The third rotator 450 may be fastened to a first hinge plate 166, and the fourth rotator 460 may be fastened to a second hinge plate 167. The third rotator 450 may be coupled to the first hinge plate 166 through fastening means and fastening holes 550a and 550b (or grooves), and the fourth rotator 460 may be coupled to the second hinge plate 167 through fastening means and fastening holes 560a and 560b (or grooves). The third bracket 471 may be fastened to the first support member 170. The fourth bracket 472 may be fastened to the second support member 180. The third bracket 471 may be coupled to the first support member 170 by fastening means and fastening holes 471a and 471b (or grooves), and the fourth bracket 472 may be coupled to the second support member 180 by fastening means and fastening holes 472a and 472b (or grooves). The fastening means may include a bolt and/or a nut for screw coupling, a hook structure for hook coupling, or a fitting structure including a groove (or an opening) and a protrusion. Although it has been described that the third bracket 471 (or the fourth bracket 472) is connected to the first support member 170 (or the second support member 180) through physical coupling, it is not limited thereto. The third bracket 471 (or the fourth bracket 472) may be coupled to the first support member 170 (or the second support member 180) by bonding (or welding) or by using an adhesive member (tape, adhesive, or double-sided tape). Coupling between the third rotator 450 and the first hinge plate 166 and coupling between the fourth rotator 460 and the second hinge plate 167 may also be implemented by methods other than physical coupling.

A portion of the first bracket 410 (or the second bracket 420) and a portion of the third bracket 471 (or the fourth bracket 472), which are fastened to the first support member 170 (or the second support member 180), may move substantially identically about the folding axis 137. The first rotator 310 (or the second rotator 320) may rotate about the first axis a1 (or the second axis a2), and the third rotator 450 (or the fourth rotator 460) may rotate about the third axis a3 (or the fourth axis a4). The first axis a1 (or the second axis a2) may be parallel to the third axis a3 (or the fourth axis a4) and may be different from the third axis a3 (or the fourth axis a4). The first bracket 410 (or the second bracket 420) connected to the first rotator 310 (or the second rotator 320) and the third bracket 471 (or the fourth bracket 472) connected to the third rotator 450 (or the fourth rotator 460) may perform motion to compensate for a difference in rotation angles generated as they rotate about different axes a1, a2, a3, and a4. For example, the first bracket 410 may slide from the first rotator 310 or may rotate about a point within the first rotator 310. The third bracket 471 may slide along the guide rail of the third rotator 450 or may rotate about a point within the third rotator 450.

When the first bracket 410 (or the second bracket 420) is configured to move linearly (e.g., in an extension direction of the first rotator 310 (or the second rotator 320)), the third bracket 471 (or the fourth bracket 472) may have an inclination with respect to the third rotator 450 (or the fourth rotator 460). As the third bracket 471 (or the fourth bracket 472) fastened to the first hinge plate 166 (or the second hinge plate 167) has an inclination with respect to the third rotator 450 (or the fourth rotator 460), the first support member 170 (or the second support member 180) may have an inclination with respect to the first hinge plate 166 (or the second hinge plate 167). As the first support member 170 (or the second support member 180) has an inclination with respect to the first hinge plate 166 (or the second hinge plate 167), a bending portion 130-1 of a flexible display 130 supported by or connected to the first support member 170, the second support member 180, the first hinge plate 166, and the second hinge plate 167 may have a dumbbell shape or a teardrop shape. For example, a distance between the first support member 170 and the second support member 180, which are positioned at a boundary of the bending portion 130-1, may be formed narrowly, and a distance between the first hinge plate 166 and the second hinge plate 167 may become wider toward a hinge cover 165. A hinge structure 160 or the hinge assembly 162 may be referred to as a dumbbell hinge structure, a teardrop hinge structure, a dumbbell hinge assembly, or a teardrop hinge assembly, in terms of providing the bending portion 130-1 of the flexible display 130 in a folded state in a dumbbell shape or a teardrop shape.

The hinge assembly 162 may include the first rack gear 330, the second rack gear 340, and the elastic member 350 to maintain symmetry about the folding axis. The hinge assembly 162 including the first rack gear 330, the second rack gear 340, and the elastic member 350 may be configured such that components of the hinge assembly 162 move symmetrically about the folding axis 137 to provide the bending portion 130-1 of the flexible display 130 in a teardrop shape or a dumbbell shape.

The hinge assembly 162 may further include structures capable of implementing a detent by being coupled to the first shaft 461 and the second shaft 462. The hinge structure 160 may include detent structures providing designated pressure to structures 461a and 461b formed on the shafts 461 and 462. The hinge assembly 162 may further include a support plate 561, washer rings 562-1 and 562-2, a fixed cam 563, rotation cams 564-1 and 564-2, elastic members 570-1 and 570-2, and fixing members 490-1 and 490-2. The hinge assembly 162 may support cam operation through engagement between the fixed cam 563 and the rotation cam 564 by pushing the fixed cam 563 and the rotation cam 564 in a direction of the structures 461a and 461b based on elastic force of the elastic member 570. The hinge assembly 162 may maintain a state through engagement between the fixed cam 563 and the rotation cam 564, not only in an unfolded state or a folded state of housings 110 and 120, but also in an intermediate state at a designated angle (e.g., an angle between the first housing 110 and the second housing 120 of 30 degrees, 90 degrees, or 120 degrees).

The support plate 561 may be penetrated by the first shaft 461 and the second shaft 462. The support plate 561 may include openings through which the first shaft 461 and the second shaft 462 pass, respectively. The washer rings 562-1 and 562-2 may be inserted onto the first shaft 461 and the second shaft 462, respectively. The washer rings 562-1 and 562-2 may be disposed between the support plate 561 and the fixed cam 563. When a plurality of support plates 561 are provided, some of the washer rings 562-1 and 562-2 may be disposed between the support plates. While the hinge assembly 162 changes about the folding axis, frictional force may be generated between the washer rings 562-1 and 562-2. By contacting the washer rings 562-1 and 562-2 while frictional force is generated, the support plate 561 may provide frictional force that limits rotation of the first shaft 461 and the second shaft 462 by the washer rings 562-1 and 562-2. For example, positions of the first rotator 310 connected to the first shaft 461 and the second rotator 320 connected to the second shaft 462 may be maintained by frictional force between the washer rings 562-1 and 562-2 and the support plate 561 even when external force applied to the first rotator 310 and the second rotator 320 is removed. As the first rotator 310 and the second rotator 320 maintain angles at various angles, an electronic device 101 (e.g., the electronic device 101 of FIG. 1A) may maintain a posture in an intermediate state between the folded state and the unfolded state.

The fixed cam 563 may include a hole through which each of the first shaft 461 and the second shaft 462 penetrates, and may include a cam structure (e.g., a cam peak and a cam valley) formed around the hole. The fixed cam 563 may be connected to the first shaft 461 and the second shaft 462 such that rotation of the fixed cam 563 with respect to the shafts 461 and 462 may be limited. The rotation cams 564-1 and 564-2 may be disposed to face the cam structure of the fixed cam 563. For example, a first rotation cam 564-1 may be inserted onto the first shaft 461 and may face a cam structure of the fixed cam 563 disposed on the first shaft 461. A second rotation cam 564-2 may be inserted onto the second shaft 462 and may face a cam structure of the fixed cam 563 disposed on the second shaft 462. The first rotation cam 564-1 and the second rotation cam 564-2 may include at least one valley or peak facing the cam structure of the fixed cam 563. The peak and valley of the cam structure may include a flat area. While the first rotation cam 564-1 and the second rotation cam 564-2 rotate while being engaged with the fixed cam 563, when the peak of the fixed cam 563 and peaks of the rotation cams 564-1 and 564-2 are engaged, elastic force may increase, thereby firmly maintaining an intermediate state. The elastic force may be provided through the elastic members 570-1 and 570-2. The elastic members 570-1 and 570-2 may be disposed between the fixing members 490-1 and 490-2 and the cams (e.g., the first rotation cam 564-1, the second rotation cam 564-2, and the fixed cam 563). For example, the first elastic member 570-1 may be disposed between the first rotation cam 564-1 and the first fixing member 490-1. The first elastic member 570-1 may provide elastic force to the first rotation cam 564-1 and the first fixing member 490-1. The second elastic member 570-2 may be disposed between the second rotation cam 564-2 and the second fixing member 490-2. The second elastic member 570-2 may provide elastic force to the second rotation cam 564-2 and the second fixing member 490-2. When the peak of the fixed cam 563 and the peaks of the rotation cams 564-1 and 564-2 are engaged, the elastic members 570-1 and 570-2 may be compressed to press the fixed cam 563 and the rotation cams 564-1 and 564-2. The pressed fixed cam 563 and rotation cams 564-1 and 564-2 may increase frictional force between the washer rings 562-1 and 562-2 and the support plate 561 by pressing the washer rings 562-1 and 562-2 and the support plate 561. The elastic members 570-1 and 570-2 may maintain an intermediate state within a designated angle by increasing frictional force. The elastic members 570-1 and 570-2 may be a disc spring having high elasticity. However, it is not limited thereto, and the elastic members 570-1 and 570-2 may include coil springs surrounding the shafts 461 and 462, respectively, or springs or elastic bodies capable of providing restoring force through compression and tension.

The hinge assembly 162 may include guide members 580-1, 580-2, 580-3, and 580-4. The guide members 580-1, 580-2, 580-3, and 580-4 may be in a clip form surrounding a portion of a rotation axis. The guide members 580-1, 580-2, 580-3, and 580-4 may be coupled to a plate disposed in the hinge assembly 162 among plates 261-1, 261-2, and 261-3. The guide members 580-1, 580-2, 580-3, and 580-4 may rotate by the shafts 461 and 462, and by the rotation, a plate coupled to the hinge assembly 162 among the plates 261-1, 261-2, and 261-3 may move upward and downward.

According to the above-described embodiment of the disclosure, the hinge assembly 162 may be configured such that components of the hinge assembly 162 move symmetrically about the folding axis 137, thereby preventing or reducing twisting of the first housing 110 and the second housing 120.

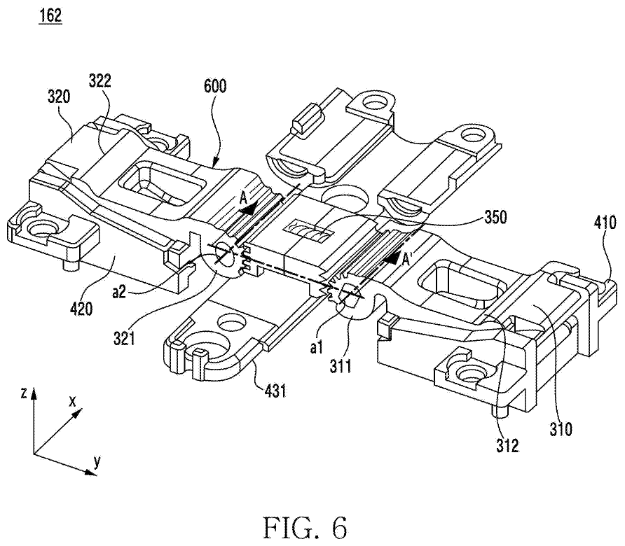

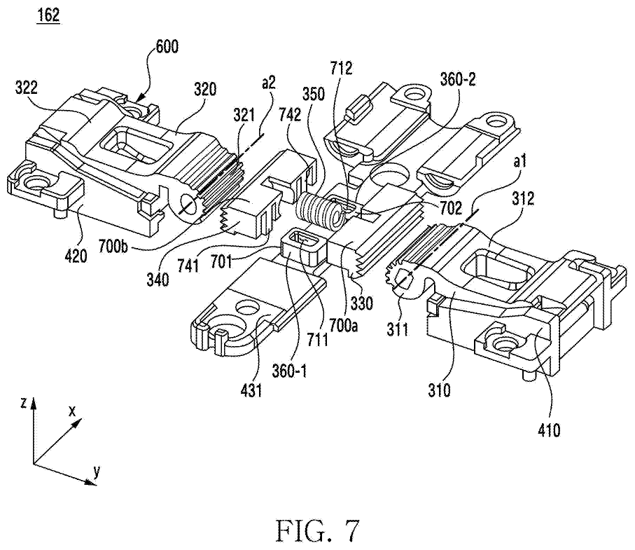

FIG. 6 is a drawing illustrating a coupling relationship between rotators and rack gears of a hinge assembly according to an embodiment of the disclosure. FIG. 7 is an exploded perspective view illustrating rotators and rack gears of the hinge assembly according to an embodiment of the disclosure.

Referring to FIGS. 6 and 7, a hinge assembly 162 may include a hinge linkage structure 600. The hinge linkage structure 600 may include a first rotator 310, a second rotator 320, a first rack gear 330, a second rack gear 340, an elastic member 350, and a guide 360. The hinge linkage structure 600 may be configured such that the first rotator 310 and the second rotator 320 move simultaneously. As the first rotator 310 and the second rotator 320 rotate to be symmetrical about a folding axis 137, a first housing 110 and a second housing 120 may rotate while maintaining symmetry about the folding axis 137. The hinge linkage structure 600 may prevent or reduce twisting of a flexible display 130 according to symmetrical movement of the first housing 110 and the second housing 120.

The hinge linkage structure 600 may be disposed on a first frame 431. The hinge linkage structure 600 may be supported by the first frame 431. The first rotator 310 may rotate about a first axis a1. The first rotator 310 may include a first gear 311 and a first support portion 312. The first support portion 312 may support or be connected to the first housing 110 (e.g., the first housing 110 of FIG. 1A) or a first support member (e.g., the first support member 170 of FIG. 1C). The first gear 311 may rotate about the first axis a1 and may be engaged with the first rack gear 330. By a rotation of the first gear 311, the first rack gear 330 may be moved in a z-axis direction. The second rotator 320 may include a second gear 321 and a second support portion 322. The second support portion 322 may support or be connected to the second housing 120 (e.g., the second housing 120 of FIG. 1A) or a second support member (e.g., the second support member 180 of FIG. 1C). The second gear 321 may rotate about a second axis a2 and may be engaged with the second rack gear 340. By a rotation of the second gear 321, the second rack gear 340 may be moved in the z-axis direction.

The elastic member 350 may be disposed between the first rack gear 330 and the second rack gear 340. The elastic member 350 may be surrounded by the first rack gear 330 and the second rack gear 340. The elastic member 350 may be compressed by the first rack gear 330 and the second rack gear 340. The compressed elastic member 350 may press inner surfaces of the first rack gear 330 and the second rack gear 340. The elastic member 350 may press the first rack gear 330 toward the first gear 311 and may press the second rack gear 340 toward the second gear 321. As the elastic member 350 provides elastic force to the first rack gear 330 toward the first gear 311 and provides elastic force to the second rack gear 340 toward the second gear 321, the first gear 311, the first rack gear 330, the second gear 321, and the second rack gear 340 may be brought into close contact. According to the first gear 311, the first rack gear 330, the second gear 321, and the second rack gear 340 in close contact, when the first gear 311 rotates, the second gear 321 may rotate in a direction opposite to a rotation direction of the first gear 311. A rotation speed of the first gear 311 may be substantially the same as a rotation speed of the second gear 321. A rotation speed of the first rack gear 330 moved in the z-axis direction according to a rotation of the first gear 311 may be substantially the same as a rotation speed of the second rack gear 340 moved in the z-axis direction according to a rotation of the second gear 321. The elastic member 350 may be exposed to the outside through an open portion of the first rack gear 330 and the second rack gear 340. For example, a removed portion (e.g., a groove) of the first rack gear 330 and a removed portion of the second rack gear 340 facing the removed portion of the first rack gear 330 may include an open structure (a hole, an opening, or a spaced gap) exposing the elastic member 350.

The guide 360 may guide movement of the first rack gear 330 and the second rack gear 340 in the z-axis direction. The guide 360 may protrude from a surface of the first frame 431 in a direction toward the flexible display 130 (e.g., a +z-axis direction). The guide 360 may extend in a movement direction (e.g., the z-axis direction) of the first rack gear 330 and the second rack gear 340. To allow the first rack gear 330 and the second rack gear 340 to be movably coupled to the guide 360, the first rack gear 330, the second rack gear 340, and the guide 360 may include a coupling structure.

The guide 360 may include groove 711 and 712 capable of accommodating a portion of the first rack gear 330 and the second rack gear 340. The guide 360 may include the groove 711 and 712 recessed from a surface facing the first rack gear 330 and the second rack gear 340. A plurality of guides 360 may be provided. For example, a first guide 360-1 and a second guide 360-2 may be disposed on the first frame 431. The first guide 360-1 and the second guide 360-2 may be disposed inside the first rack gear 330 and the second rack gear 340. For example, the first guide 360-1 and the second guide 360-2 may be surrounded by the first rack gear 330 and the second rack gear 340. The first guide 360-1 may be spaced apart from the second guide 360-2. The elastic member 350 may be disposed between the first guide 360-1 and the second guide 360-2. The first guide 360-1 may include a partition wall 701 for forming the groove 711. The partition wall 701 may be formed along an edge of the groove 711, and the first guide 360-1 may have a hollow polygonal pipe shape. An end of the partition wall 701 may be connected to a surface of the first frame 431. The second guide 360-2 may include a partition wall 702 for forming the groove 712. The partition wall 702 may be formed along an edge of the groove 712, and the second guide 360-2 may have a hollow polygonal pipe shape. An end of the partition wall 702 may be connected to a surface of the first frame 431.

The first rack gear 330 and the second rack gear 340 may include rods 741 and 742 inserted into the grooves 711 and 712 of the first guide 360-1 and the second guide 360-2, respectively. The rods 741 and 742 may extend toward the first frame 431 from an inner surface (e.g., a surface facing the grooves 711 and 712) of an upper portion 700b of the second rack gear 340. Rods (not illustrated) of the first rack gear 330 may extend toward the first frame 431 from an inner surface of an upper portion 700a of the first rack gear 330. The rods 741 and 742 may be moved in the z-axis direction within the grooves 711 and 712. By the rods 741 and 742 inserted into the grooves 711 and 712, respectively, the first rack gear 330 and the second rack gear 340 may be moved in the z-axis direction.

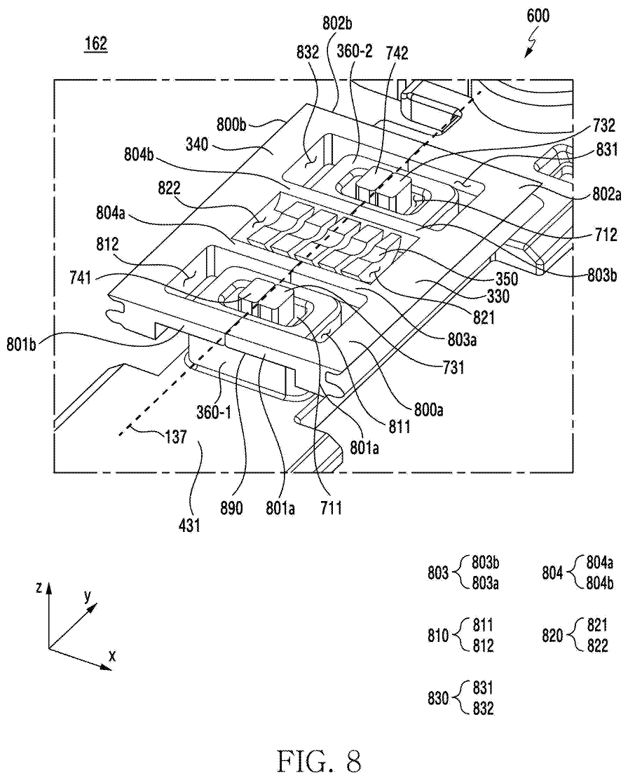

FIG. 8 is a drawing illustrating a guide structure of a hinge assembly according to an embodiment of the disclosure.

Referring to FIG. 8, a first rack gear 330 and a second rack gear 340 of a hinge linkage structure 600 may provide at least one space 810, 820, and 830 for accommodating guides 360-1 and 360-2 and an elastic member 350.

The first rack gear 330 may include sidewalls 800a, 801a, and 802a extending from an upper portion 700a in a first direction (a z-axis direction). The sidewalls 800a, 801a, and 802a may form an exterior of the first rack gear 330. The sidewalls 800a, 801a, and 802a of the first rack gear 330 may extend from the upper portion (e.g., the upper portion 700a of FIG. 7) toward a first frame 431. The first rack gear 330 may include a first sidewall 800a, a second sidewall 801a, and a third sidewall 802a. The first sidewall 800a may extend in a second direction (e.g., a y-axis direction) parallel to a folding axis. The second sidewall 801a may be bent from an end of the first sidewall 800a and extend in a third direction (e.g., an x-axis direction). The third sidewall 802a may be bent from another end of the first sidewall 800a and extend in the third direction (e.g., the x-axis direction). The third sidewall 802a may be parallel to the second sidewall 801a. The second sidewall 801a and the third sidewall 802a may extend from both ends of the first sidewall 800a toward the second rack gear 340.

The second rack gear 340 may include sidewalls 800b, 801b, and 802b extending from an upper portion 700b in the first direction (the z-axis direction). The sidewalls 800b, 801b, and 802b may form an exterior of the second rack gear 340. The sidewalls 800b, 801b, and 802b of the second rack gear 340 may extend from the upper portion (e.g., the upper portion 700b of FIG. 7) toward the first frame 431. The second rack gear 340 may include a fourth sidewall 800b, a fifth sidewall 801b, and a sixth sidewall 802b. The fourth sidewall 800b may extend in the second direction (e.g., the y-axis direction) parallel to the folding axis. The fifth sidewall 801b may be bent from an end of the fourth sidewall 800b and extend in the third direction (e.g., the x-axis direction). The sixth sidewall 802b may be bent from another end of the fourth sidewall 800b and extend in the third direction (e.g., the x-axis direction). The sixth sidewall 802b may be parallel to the fifth sidewall 801b. The fifth sidewall 801b and the sixth sidewall 802b may extend from both ends of the fourth sidewall 800b toward the first rack gear 330.

The first sidewall 800a may include gear teeth of the first rack gear 330 exposed toward a first gear (e.g., the first gear 311 of FIGS. 3A and 3B). The fourth sidewall 800b may include gear teeth of the second rack gear 340 exposed toward a second gear (e.g., the second gear 321 of FIGS. 3A and 3B).

The first rack gear 330 and the second rack gear 340 may respectively surround a first guide 360-1, the elastic member 350, and a second guide 360-2. The first rack gear 330 and the second rack gear 340 may further include partition walls 803 and 804 to provide spaces 810, 820, and 830 surrounding the first guide 360-1, the elastic member 350, and the second guide 360-2. According to an arrangement of the first guide 360-1, the elastic member 350, the second guide 360-2, the first rack gear 330, and the second rack gear 340, the partition walls 803 and 804 may be omitted. For example, when a lateral side of the elastic member 350 is adjacent to the first guide 360-1 and the second guide 360-2 such that the elastic member 350 is disposable in a designated area within a space in the first rack gear 330 and the second rack gear 340, the partition walls 803 and 804 may be omitted.

The first rack gear 330 may include a first partition wall 803a and a second partition wall 803b. The first partition wall 803a and the second partition wall 803b may be formed parallel to the second sidewall 801a and the third sidewall 802a. The first partition wall 803a and the second partition wall 803b may extend from the first sidewall 800a toward the second rack gear 340. The first partition wall 803a may be disposed between the first guide 360-1 and the elastic member 350. The second partition wall 803b may be disposed between the elastic member 350 and the second guide 360-2. The second rack gear 340 may include a third partition wall 804a and a fourth partition wall 804b. The third partition wall 804a and the fourth partition wall 804b may be formed parallel to the fifth sidewall 801b and the sixth sidewall 802b. The third partition wall 804a and the fourth partition wall 804b may extend from the fourth sidewall 800b toward the first rack gear 330. The third partition wall 804a may be disposed between the first guide 360-1 and the elastic member 350. The fourth partition wall 804b may be disposed between the elastic member 350 and the second guide 360-2.

The first rack gear 330 and the second rack gear 340 may provide a space 810 surrounding the first guide 360-1. A portion of the first sidewall 800a, the second sidewall 801a, and the first partition wall 803a of the first rack gear 330, together with a portion of the fourth sidewall 800b, the fifth sidewall 801b, and the third partition wall 804a of the second rack gear 340, may surround the first guide 360-1. A portion of the first sidewall 800a, the second sidewall 801a, and the first partition wall 803a of the first rack gear 330, together with a portion of the fourth sidewall 800b, the fifth sidewall 801b, and the third partition wall 804a of the second rack gear 340, may define a space in which the first guide 360-1 is accommodated. The space 810 surrounding the first guide 360-1 may be configured with a first partial space 811 and a second partial space 812. For example, a portion of the first sidewall 800a, the second sidewall 801a, and the first partition wall 803a of the first rack gear 330 may provide the first partial space 811 partially surrounding the first guide 360-1. A portion of the fourth sidewall 800b, the fifth sidewall 801b, and the third partition wall 804a of the second rack gear 340 may provide the second partial space 812 partially surrounding the first guide 360-1.

The first rack gear 330 and the second rack gear 340 may provide a space 820 surrounding the elastic member 350. A portion of the first sidewall 800a, the first partition wall 803a, and the second partition wall 803b of the first rack gear 330, together with a portion of the fourth sidewall 800b, the third partition wall 804a, and the fourth partition wall 804b of the second rack gear 340, may surround the elastic member 350. A portion of the first sidewall 800a, the first partition wall 803a, and the second partition wall 803b of the first rack gear 330, together with a portion of the fourth sidewall 800b, the third partition wall 804a, and the fourth partition wall 804b of the second rack gear 340, may define a space in which the elastic member 350 is accommodated. The space 820 surrounding the elastic member 350 may be configured with a third partial space 821 and a fourth partial space 822. For example, a portion of the first sidewall 800a, the first partition wall 803a, and the second partition wall 803b of the first rack gear 330 may provide the third partial space 821 partially surrounding the elastic member 350. A portion of the fourth sidewall 800b, the third partition wall 804a, and the fourth partition wall 804b of the second rack gear 340 may provide the fourth partial space 822 partially surrounding the elastic member 350.

The first rack gear 330 and the second rack gear 340 may provide a space 830 surrounding the second guide 360-2. A portion of the first sidewall 800a, the third sidewall 802a, and the second partition wall 803b of the first rack gear 330, together with a portion of the fourth sidewall 800b, the sixth sidewall 802b, and the fourth partition wall 804b of the second rack gear 340, may surround the second guide 360-2. A portion of the first sidewall 800a, the third sidewall 802a, and the second partition wall 803b, together with a portion of the fourth sidewall 800b, the sixth sidewall 802b, and the fourth partition wall 804b of the second rack gear 340, may define a space in which the second guide 360-2 is accommodated. The space 830 surrounding the second guide 360-2 may be configured with a fifth partial space 831 and a sixth partial space 832. For example, a portion of the first sidewall 800a, the third sidewall 802a, and the second partition wall 803b of the first rack gear 330 may provide the fifth partial space 831 partially surrounding the second guide 360-2. A portion of the fourth sidewall 800b, the sixth sidewall 802b, and the fourth partition wall 804b of the second rack gear 340 may provide the sixth partial space 832 partially surrounding the second guide 360-2.

The first rack gear 330 may include a first rod 731 and a second rod 732 to be movably coupled to the guide 360. The second rack gear 340 may include a third rod 741 and a fourth rod 742 to be movably coupled to the guide 360. The first guide 360-1 may include a groove 711 recessed inwardly toward the first frame 431. The first rod 731 of the first rack gear 330 may be accommodated in the groove 711 of the first guide 360-1. The third rod 741 of the second rack gear 340 may be accommodated in the groove 711 of the first guide 360-1. The second guide 360-2 may include a groove 712 recessed inwardly toward the first frame 431. The second rod 732 of the first rack gear 330 may be accommodated in the groove 712 of the second guide 360-2. The fourth rod 742 of the second rack gear 340 may be accommodated in the groove 712 of the second guide 360-2.

The first guide 360-1 and the second guide 360-2 may be formed in a polygonal shape. To correspond to a shape of rods inserted into the first guide 360-1 and the second guide 360-2, the first guide 360-1 and the second guide 360-2 may be symmetrical about a folding axis 137.

As the guides 360-1 and 360-2 and the grooves 711 and 712 are formed in a polygonal shape, the first guide 360-1 and the second guide 360-2 are configured to limit movement in a second direction (e.g., the x-axis direction or the y-axis direction) different from a first direction (e.g., the z-axis direction), while the first rack gear 330 and the second rack gear 340 move in the first direction along the guides 360-1 and 360-2, and as the first guide 360-1 and the second guide 360-2 are formed in a polygonal shape, the first rack gear 330 and the second rack gear 340 may move in the z-axis direction, and movement in the y-axis direction and the x-axis direction may be limited by the partition walls 803a, 803b, 804a, and 804b and the sidewalls 800a, 800b, 801a, 801b, 802a, and 802b surrounding the first guide 360-1 and the second guide 360-2. The groove 711 of the first guide 360-1 and the groove 712 of the second guide 360-2 may also be formed in a polygonal shape such that the rods 731, 732, 741, and 742 and the grooves 711 and 712 are engaged with each other, and the first rack gear 330 and the second rack gear 340 may move in the z-axis direction, and movement in the y-axis direction and the x-axis direction may be limited.

When the first rack gear 330 and the second rack gear 340 move in a-z-axis direction, a lower portion of the first rack gear 330 and a lower portion of the second rack gear 340 may contact the first frame 431. For example, lower portions of the second sidewall 801a, the third sidewall 802a, the fifth sidewall 801b, the sixth sidewall 802b, and the partition walls 803a, 803b, 804a, and 804b may have a stopper 890 in a groove form capable of accommodating a portion of the first frame 431. When an electronic device (e.g., the electronic device 101 of FIG. 1A) is in a folded state, a portion of the first frame 431 may contact the stopper 890. Movement of the first rack gear 330 and the second rack gear 340 in the-z-axis direction may be limited by contact between the stopper 890 and the first frame 431. As movement of the first rack gear 330 and the second rack gear 340 is limited, excessive folding of the electronic device 101 or excessive rotation of the gears 311 and 321 may be limited.

The guides 360-1 and 360-2 having grooves and exteriors of polygonal shape described above may move the first rack gear 330 and the second rack gear 430 in the z-axis direction without deviation to one side. As the first rack gear 330 and the second rack gear 340 move without deviation, a movement distance of the first rack gear 330 and the second rack gear 340 in the z-axis direction may also be substantially the same.

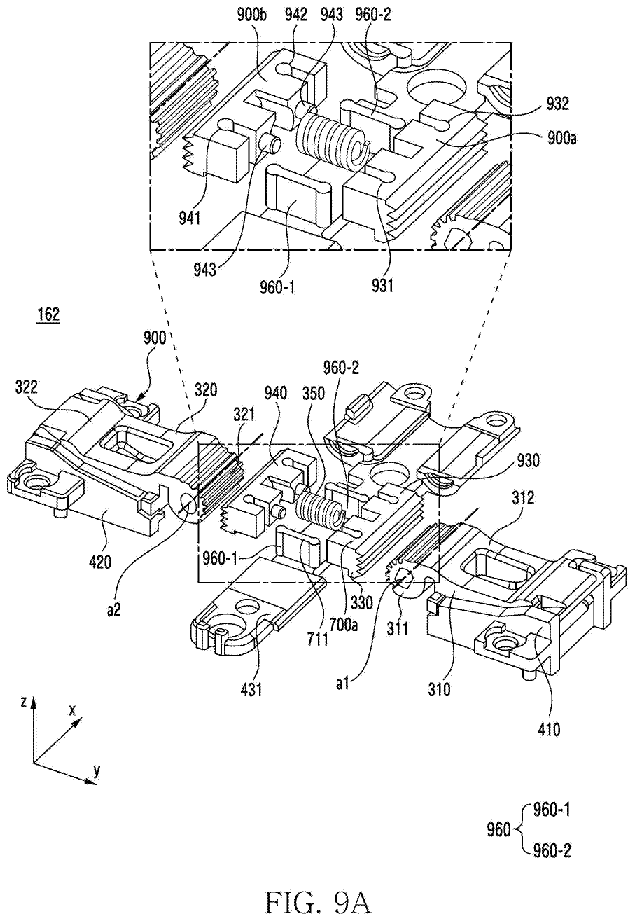

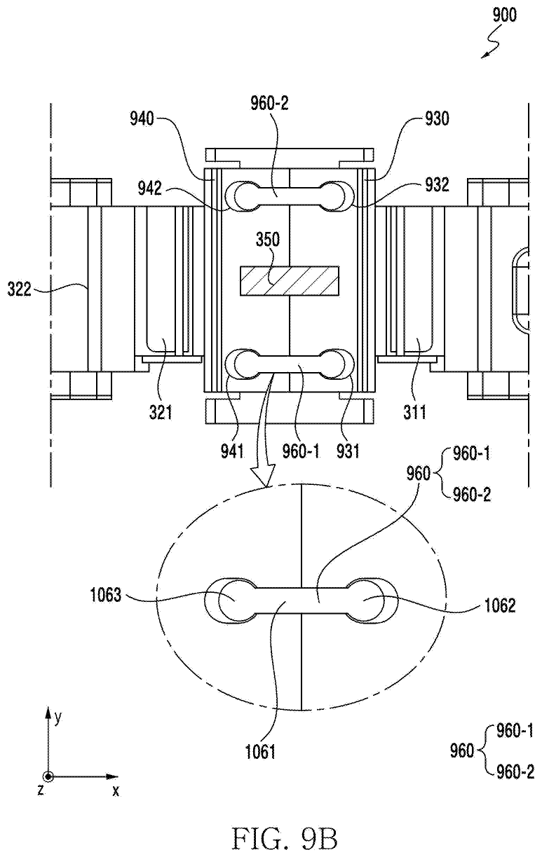

FIGS. 9A and 9B are drawings illustrating a hinge assembly including a dumbbell-shaped guide structure according to various embodiments of the disclosure.

Referring to FIGS. 9A and 9B, a hinge assembly 162 may include a hinge linkage structure 900. The hinge linkage structure 900 may include a first rotator 310, a second rotator 320, a first rack gear 930, a second rack gear 940, an elastic member 350, and a guide 960. The hinge linkage structure 900 may be configured such that the first rotator 310 and the second rotator 320 move simultaneously. As the first rotator 310 and the second rotator 320 rotate to be symmetrical about a folding axis 137, a first housing 110 and a second housing 120 may rotate while maintaining symmetry about the folding axis 137. The hinge linkage structure 900 may prevent or reduce twisting of a flexible display 130 according to symmetrical movement of the first housing 110 and the second housing 120.

Among the hinge linkage structure 900, a configuration of the first rotator 310 and the second rotator 320 may be the same as or similar to the first rotator 310 and the second rotator 320 of FIGS. 3A, 3B, and 4 to 8. Identical or similar details of the configuration of the first rotator 310 and the second rotator 320 are omitted. The elastic member 350 disposed between the first rack gear 930 and the second rack gear 940 may press the first rack gear 930 and the second rack gear 940. The first rotator 310 and the first rack gear 930 may be in close contact by the elastic member 350 pressing the first rack gear 930 toward the first rotator 310. The second rotator 320 and the second rack gear 940 may be in close contact by the elastic member 350 pressing the second rack gear 940 toward the second rotator 320.

The guide 960 may guide the first rack gear 930 engaged with a first gear 311 and the second rack gear 940 engaged with a second gear 321 to move in a designated path (e.g., a movement path in a z-axis direction) while the first rotator 310 rotates about a first axis a1 and the second rotator 320 rotates about a second axis a2. A plurality of guides 960 may be provided. A first guide 960-1 and a second guide 960-2 may protrude from a first frame 431 in a direction toward the first rack gear 930 and the second rack gear 940. The first guide 960-1 and the second guide 960-2 may be spaced apart from each other. The elastic member 350 may be disposed between the first guide 960-1 and the second guide 960-2. A cross-section of the guides 960-1 and 960-2 may have a shape in which widths of both end portions are wider than a width of another portion. The first guide 960-1 and the second guide 960-2 may protrude in a plate shape toward the z-axis direction and may have a column shape at an edge portion. The cross-section of the first guide 960-1 and the second guide 960-2 may have a dumbbell shape. For example, a central portion 1061 of the cross-section of the guide 960 may be thinner than both end portions 1062 and 1063. Both end portions 1062 and 1063 may have a cylindrical column shape. A thickness of the central portion 1061 may be thinner than a diameter of an end portion 1062 having a cylindrical shape.

The first rack gear 930 and the second rack gear 940 may have structures 931, 932, 941, and 942 surrounding a lateral side of the guide. The structures 931 and 932 of the first rack gear 930 and the structures 941 and 942 of the second rack gear 940 may correspond to a shape of the guide 960. The structures 931 and 932 of the first rack gear 930 may accommodate a portion of the guide 960, and the structures 931 and 932 of the second rack gear 940 may accommodate another portion of the guide 960. The structures 931 and 932 of the first rack gear 930 and the structures 941 and 942 of the second rack gear 940 corresponding thereto may face each other and provide a guide-shaped hole capable of accommodating the guide 960. The first rack gear 930 and the second rack gear 940, having the structures 931, 932, 941, and 942 of a shape corresponding to the guide 960, may move in the z-axis direction along the guide 960. The second rack gear 940 may further include at least one protrusion 943 formed toward the first rack gear 930. The first rack gear 930 may further include a groove (not illustrated) corresponding to the at least one protrusion 943. The at least one protrusion 943 may protrude from a surface facing the first rack gear 930 toward the first rack gear 930. The groove may be recessed from a surface of the first rack gear 930 facing the second rack gear 940. The protrusion 943 may be at least partially inserted into the groove. Through coupling of the protrusion 943 and the groove, the first rack gear 930 and the second rack gear 940 may move together in the z-axis direction.

As the guide 960 is formed in the dumbbell shape, even when the first rack gear 930 and the second rack gear 940 are pressed by the elastic member 350, movement of the first rack gear 930 and the second rack gear 940 may be limited. For example, when force in an x-axis direction is applied to the first rack gear 930 by the elastic member 350, the first rack gear 930 may contact the end portion 1062 of the guide 960. Movement of the first rack gear 930, in contact with the end of the guide 960, in the x-axis direction may be limited. When force in a-x-axis direction is applied to the second rack gear 940 by the elastic member 350, the second rack gear 940 may contact the another end portion 1063 of the guide 960. Movement of the second rack gear 940, in contact with the another end portion 1063 of the guide 960, in the x-axis direction may be limited.

The structures 931 and 932 of the first rack gear 930 and the structures 941 and 942 of the second rack gear 940 may be disposed adjacent to the guide 960 in a y-axis direction (or a folding axis direction). By the structures and the guide 960 disposed adjacent to each other, movement of the first rack gear 930 and the second rack gear 940 in the y-axis direction may be limited.

According to the above-described embodiment of the disclosure, a guide structure 360-1, 360-2 of the hinge assembly 162 may be configured as a dumbbell-shaped plate and may limit movement of the first rack gear 930 and the second rack gear 940 in a direction different from a movement direction while guiding movement of the first rack gear 930 and the second rack gear 940. As the first rack gear 930 and the second rack gear 940 move in a designated direction, twisting between a first housing (e.g., the first housing 110 of FIG. 1A) and a second housing (e.g., the second housing 120 of FIG. 1A) may be reduced. As the first housing 110 and the second housing 120 rotate while maintaining symmetry, damage to a flexible display (e.g., the flexible display 130 of FIG. 1A) may be reduced.

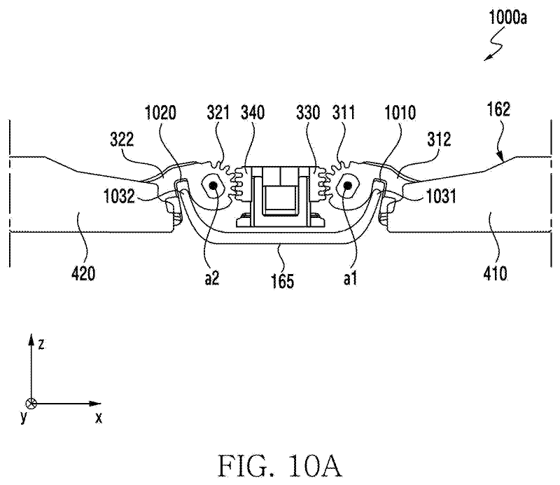

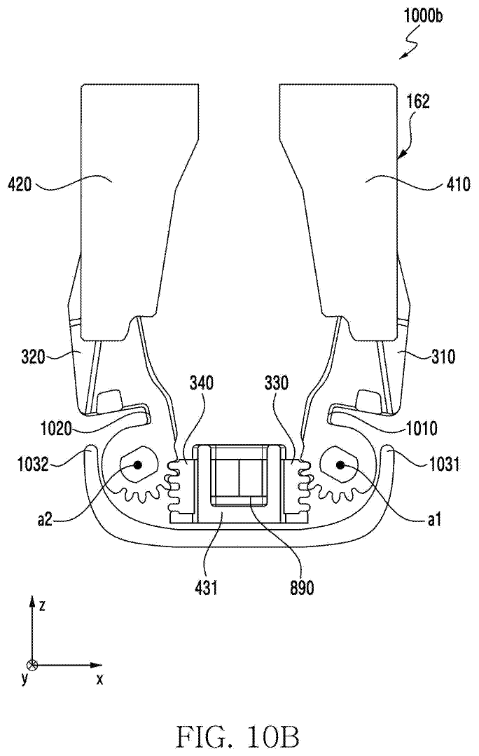

FIG. 10A is a drawing illustrating an unfolded state of a hinge assembly according to an embodiment of the disclosure. FIG. 10B is a drawing illustrating a closed state of a hinge assembly according to an embodiment of the disclosure.

Referring to FIGS. 10A and 10B, while an electronic device changes to an unfolded state 1000a by a hinge assembly 162, the hinge assembly 162 may further include a structure for limiting a rotation of a first rotator 310 and a second rotator 320.

Both sides 1031 and 1032 of a hinge cover 165 of an electronic device 101 may contact a portion of the first rotator 310 and the second rotator 320.

The first rotator 310 may include a first neck 1010 disposed between a first gear 311 and a first support portion 312. The second rotator 320 may include a second neck 1020 disposed between a second gear 321 and a second support portion 322. The first neck 1010 may be a relatively thin portion of the first rotator 310. The second neck 1020 may be a relatively thin portion of the second rotator 320. For example, a portion in which the first neck 1010 and the second neck 1020 are disposed may provide a groove in which the both sides 1031 and 1032 of the hinge cover 165 may be accommodated. As the first neck 1010 connects upper portions of the first gear 311 and the first support portion 312, the first rotator 310 may provide a groove in which the side 1031 of the hinge cover 165 may be accommodated. As the second neck 1020 connects upper portions of the second gear 321 and the second support portion 322, the second rotator 320 may provide a groove in which the other side 1032 of the hinge cover 165 may be accommodated.

While the electronic device changes to the unfolded state 1000a by the hinge assembly 162, both sides 1031 and 1032 of the hinge cover 165 may contact the first neck 1010 of the first rotator 310 and the second neck 1020 of the second rotator 320. While the electronic device changes to the unfolded state 1000a by the hinge assembly 162, the first rotator 310 may rotate clockwise about a first axis a1. When the first rotator 310 rotates clockwise and the first neck 1010 contacts the side 1031 of the hinge cover 165, rotation of the first rotator 310 may be limited by the side 1031 of the hinge cover 165. While the electronic device changes to the unfolded state 1000a by the hinge assembly 162, the second rotator 320 may rotate counterclockwise about a second axis a2. When the second rotator 320 rotates counterclockwise and the second neck 1020 contacts the other side 1032 of the hinge cover 165, rotation of the second rotator 320 may be limited by the other side 1032 of the hinge cover 165.

While the electronic device changes to a folded state 1000b by the hinge assembly 162, the first rotator 310 and the second rotator 320 may rotate. Rotation of the first rotator 310 and the second rotator 320 may be stopped by a first rack gear 330 and a second rack gear 340. In the folded state 1000b of the electronic device 101, a stopper 890 having a groove shape and formed at lower portions of the first rack gear 330 and the second rack gear 340 may contact a first frame 431. Movement of the first rack gear 330 and the second rack gear 340 in a-z-axis direction may be limited by the stopper 890 contacting the first frame 431. According to limitation of movement of the first rack gear 330 and the second rack gear 340, rotation of the first rotator 310 and the second rotator 320 may be limited.

According to the above-described embodiment of the disclosure, by limiting a movement range of the first rotator 310 and the second rotator 320 through a stopper or structures configured to limit rotation, the electronic device 101 may change within a range from the unfolded state 1000a to the folded state 1000b.

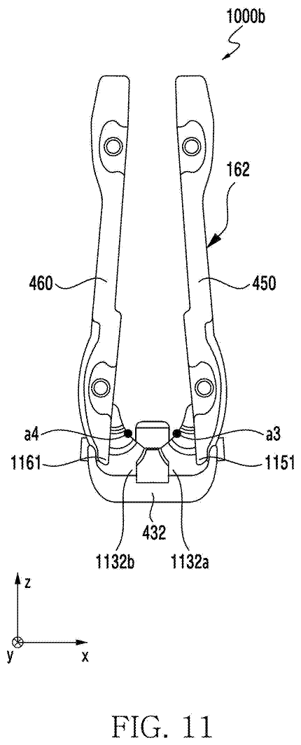

FIG. 11 illustrates a structure of a stopper for limiting movement in a closed state of a hinge assembly according to an embodiment of the disclosure.

Referring to FIG. 11, a third rotator 450 and a fourth rotator 460 of a hinge assembly 162 may be rotatably coupled to a second frame 432. The third rotator 450 and the fourth rotator 460 may rotate along rails 1132a and 1132b formed in the second frame 432. The third rotator 450 may move along a first rail 1132a and may rotate about a third axis a3. The fourth rotator 460 may move along a second rail 1132b and may rotate about a fourth axis a4. While an electronic device 101 changes to a folded state 1000b, the third rotator 450 and the fourth rotator 460 may rotate to face each other. While the electronic device 101 changes to the folded state 1000b, the third rotator 450 may rotate counterclockwise about the third axis a3, and the fourth rotator 460 may rotate clockwise about the fourth axis a4. The third rotator 450 may include a first stopper 1151 protruding from an end portion facing the second frame 432, and the fourth rotator 460 may include a second stopper 1161 protruding from an end portion facing the second frame 432. In the folded state 1000b of the electronic device 101, the first stopper 1151 of the third rotator 450 may contact a portion of the second frame 432. The portion may be formed at an end portion of the first rail 1132a. For example, at the end portion of the first rail 1132a of the second frame 432, it may protrude toward a groove of the first rail 1132a. In the folded state 1000b of the electronic device 101, the second stopper 1161 of the fourth rotator 460 may contact a portion of the second frame 432. The portion may be formed at an end portion of the second rail 1132b. For example, at the end portion of the second rail 1132b of the second frame 432, it may protrude toward a groove of the second rail 1132b.

As the first stopper 1151 contacts the end portion of the first rail 1132a and the second stopper 1161 contacts the end portion of the second rail 1132b, rotation of the third rotator 450 and the fourth rotator 460 may be limited. The third rotator 450 and the fourth rotator 460 may be connected to a first rotator 310 and a second rotator 320 through a first support member 170 (e.g., the first support member 170 of FIG. 1C) and a second support member 180 (e.g., the second support member 180 of FIG. 1C), respectively. According to limitation of the third rotator 450 and the fourth rotator 460, rotation of the first rotator 310 and the second rotator 320 may be limited.

According to the above-described embodiment of the disclosure, by limiting a movement range of the first rotator 310 and the second rotator 320 through a stopper or structures configured to limit rotation, the electronic device 101 may change within a range from an unfolded state 1000a to the folded state 1000b.

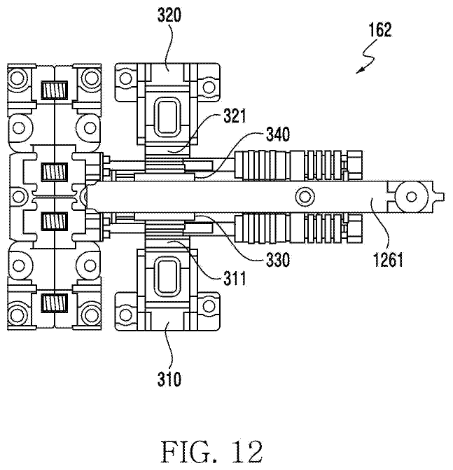

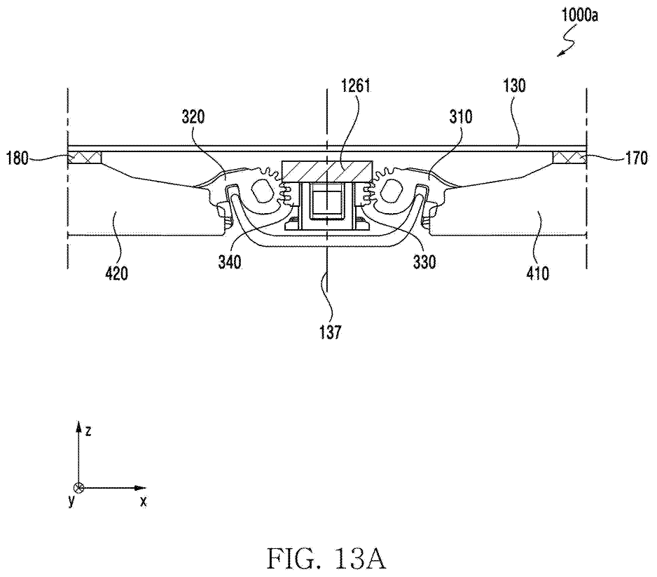

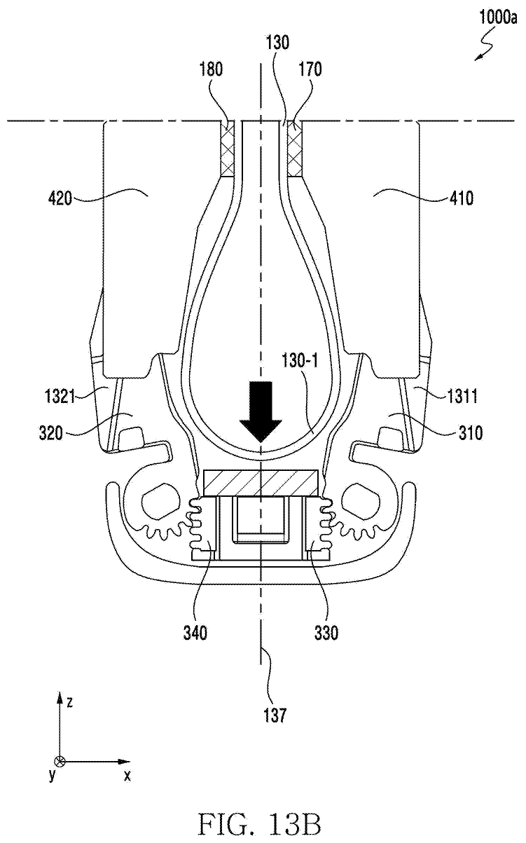

FIG. 12 is a plan view illustrating a hinge assembly including a plate assembled to rack gears according to an embodiment of the disclosure. FIG. 13A is a cross-sectional view of a foldable electronic device in an unfolded state by a hinge assembly including a plate assembled to rack gears according to an embodiment of the disclosure. FIG. 13B is a cross-sectional view of a foldable electronic device in a closed state by a hinge assembly including a plate assembled to rack gears according to an embodiment of the disclosure.

Referring to FIGS. 12, 13A, and 13B, a plate 1261 (e.g., the first plate 261-1, the second plate 261-2, or the third plate 261-3 of FIG. 2) of a hinge assembly 162 may be disposed on a first rack gear 330 and a second rack gear 340. The plate 1261 may be disposed between a first rotator 310 and a second rotator 320. The plate 1261 may be fastened to the first rack gear 330 and the second rack gear 340. The plate 1261 fastened to the first rack gear 330 and the second rack gear 340 may be moved in a z-axis direction by a rotation of the first rotator 310 and the second rotator 320. According to an embodiment of the disclosure, the plate 1261 (e.g., the first plate 261-1, the second plate 261-2, or the third plate 261-3 of FIG. 2) may be referred to as a center plate or a center bar.

In an unfolded state 1000a of an electronic device 101, the plate 1261 may be disposed in parallel with a flexible display 130 and may be spaced apart from the flexible display 130. The flexible display 130 may be supported by a first bracket 410 and a first support member 170 connected to the first rotator 310, and a second bracket 420 and a second support member 180 connected to the second rotator 320. The flexible display 130 may be bent at a bending portion 130-1 as the electronic device 101 changes from the unfolded state 1000a to a folded state 1000b. In order to compensate for a difference between a rotation distance of the first rotator 310 and the second rotator 320 rotating about a first axis a1 and a second axis a2 and a rotation distance of a third rotator 450 and a fourth rotator 460 rotating about a third axis a3 and a fourth axis a4, the first bracket 410 may move along a guide groove 1311 of the first rotator 310, and the second bracket 420 may move along a guide groove 1321 of the second rotator 320.

Due to a difference in rotation angles between the first support member 170 and the second support member 180 connected to the first bracket 410 and the second bracket 420, and a first hinge plate 166 and a second hinge plate 167 connected to the third rotator 450 and the fourth rotator 460, a shape of the bending portion 130-1 of the flexible display 130 may have a dumbbell shape within the hinge assembly 162 (or a hinge structure 160). For example, in the bending portion 130-1 surrounded by the hinge assembly 162, a distance between portions facing each other about a folding axis 137 may include a section in which the distance increases from a boundary of the bending portion 130-1 and a section in which it decreases. According to an embodiment of the disclosure, a maximum distance between the first rotator 310 and the second rotator 320 may be wider than a distance between the first support member 170 and the second support member 180. Due to such differences in distance, the bending portion 130-1 may have a teardrop shape or a dumbbell shape.

As a shape of the bending portion 130-1 of the flexible display 130 changes, the bending portion 130-1 may move in a direction toward a hinge cover 165 (a-z-axis direction). When the bending portion 130-1 sags toward the hinge cover 165, as the first rack gear 330 and the second rack gear 340 move together with the plate 1261 in the-z-axis direction, spacing between the plate 1261 and the bending portion 130-1 may be maintained.

According to an embodiment of the disclosure, as the electronic device 101 includes a hinge structure 160 having a linkage structure, a first housing 110 (or a component of the first housing 110 or a component coupled to the first housing 110) and a second housing 120 (or a component of the second housing 120 or a component coupled to the second housing 120) may move symmetrically with each other. The flexible display 130 disposed on the first housing 110 and the second housing 120 may be symmetrically folded or folded out about the folding axis 137 in accordance with linkage of the first housing 110 and the second housing 120. Damage to the flexible display 130 may be reduced by linkage of the first housing 110 and the second housing 120. The hinge structure 160 may reduce a gap or backlash between gears by close contact between a first gear 311 and the first rack gear 330 and close contact between a second gear 321 and the second rack gear 340.

The technical problems to be achieved in the disclosure are not limited to those described above, and other technical problems not mentioned herein will be clearly understood by those having ordinary knowledge in the art to which the disclosure belongs.

According to the above-described embodiment of the disclosure, a foldable electronic device (e.g., the electronic device 101 of FIG. 3B) may comprise a first housing (e.g., the first housing 110 of FIG. 3B) and a second housing (e.g., the second housing 120 of FIG. 3B). The foldable electronic device 101 may further comprise a hinge assembly (e.g., the hinge assembly 162 of FIG. 3B) rotatably coupling the first housing 110 and the second housing 120. The hinge assembly 162 may include a first rotator (e.g., the first rotator 310 of FIG. 3B). The first rotator 310 may include a first gear 311 configured to rotate about a first axis a1 and may be connected to the first housing 110. The hinge assembly 162 may further include a second rotator (e.g., the second rotator 320 of FIG. 3B). The second rotator 320 may include a second gear 321 configured to rotate about a second axis parallel to the first axis a1 and may be connected to the second housing 120. The hinge assembly 162 may further include a first rack gear 330. The first rack gear 330 (e.g., the first rack gear 330 of FIG. 3B) may be engaged with the first gear 311. The hinge assembly 162 may further include a second rack gear (e.g., the second rack gear 340 of FIG. 3B). The second rack gear 340 may be engaged with the second gear 321. The hinge assembly 162 may further include an elastic member (e.g., the elastic member 350 of FIG. 3B). The elastic member 350 may be disposed between the first rack gear 330 and the second rack gear 340 and may be configured to press the first rack gear 330 and the second rack gear 340 in a direction toward the first gear 311 and the second gear 321, respectively. The hinge assembly 162 may further include a guide 360. The guide 360 may guide movement of the first rack gear 330 and the second rack gear 340 in accordance with a rotation of the first gear 311 and the second gear 321.

According to an embodiment of the disclosure, the guide 360 may extend along a movement direction of the first rack gear 330 and the second rack gear 340.

According to an embodiment of the disclosure, the first rack gear 330 and the second rack gear 340 may be movably coupled to the guide 360.

According to an embodiment of the disclosure, the first rack gear 330 may include a first structure accommodating a portion of the guide 360.

According to an embodiment of the disclosure, the second rack gear 340 may include a second structure accommodating another portion of the guide 360.

According to an embodiment of the disclosure, the first structure, together with the second structure, may surround a lateral side of the guide 360.

According to an embodiment of the disclosure, a cross-section of the guide 360 may have a shape in which widths of both end portions are wider than a width of another portion.

According to an embodiment of the disclosure, the hinge assembly 162 may further include a frame 431 in which the guide 360 is disposed and which is configured to support the first rack gear 330 and the second rack gear 340.

According to an embodiment of the disclosure, the first rotator 310 may include a first arm moving together with the first gear 311, and a first neck disposed between the first gear 311 and the first arm.

According to an embodiment of the disclosure, the second rotator 320 may include a second arm moving together with the second gear 321, and a second neck disposed between the second gear 321 and the second arm.

According to an embodiment of the disclosure, the electronic device 101 may further comprise a hinge cover 165. The hinge cover 165 may surround the hinge assembly 162.

According to an embodiment of the disclosure, in an unfolded state in which a front surface of the first housing 110 and a front surface of the second housing 120 face the same direction, the first neck may be configured to limit a rotation of the first rotator 310 by contacting the hinge cover 165.

According to an embodiment of the disclosure, the second neck may be configured to limit a rotation of the second rotator 320 by contacting the hinge cover 165.

According to an embodiment of the disclosure, the hinge assembly 162 may further include a third rotator spaced apart from the first rotator 310 in a direction of the first axis a1 and configured to rotate about a third axis parallel to the first axis a1.

According to an embodiment of the disclosure, the hinge assembly 162 may further include a fourth rotator spaced apart from the second rotator 320 in a direction of the second axis a2 and configured to rotate about a fourth axis parallel to the second axis a2.

According to an embodiment of the disclosure, the hinge assembly 162 may further include a frame 431 supporting the first rotator 310, the second rotator 320, the third rotator, and the fourth rotator, and including a guide groove to which a portion of the third rotator and a portion of the fourth rotator are rotatably coupled.

According to an embodiment of the disclosure, the first rotator 310 and the third rotator may be coupled to the first housing 110.

According to an embodiment of the disclosure, the second rotator 320 and the fourth rotator may be coupled to the second housing 120.

According to an embodiment of the disclosure, in a folded state in which the front surface of the first housing 110 and the front surface of the second housing 120 face each other, a portion of the second rotator 320 may be configured to limit a rotation of the first housing 110 by contacting a first stopper of the frame 431.

According to an embodiment of the disclosure, in the folded state in which the front surface of the first housing 110 and the front surface of the second housing 120 face each other, a portion of the fourth rotator may be configured to limit a rotation of the second housing 120 by contacting a second stopper of the frame 431.

According to an embodiment of the disclosure, the foldable electronic device 101 may further comprise a first hinge plate coupled to the first rotator 310.

According to an embodiment of the disclosure, the foldable electronic device 101 may further comprise a second hinge plate coupled to the second rotator 320.

According to an embodiment of the disclosure, the foldable electronic device 101 may further comprise a plate disposed between the first rotator 310 and the second rotator 320 and coupled to the first rack gear 330 and the second rack gear 340.

According to an embodiment of the disclosure, the foldable electronic device 101 may further comprise a flexible display supported by the first hinge plate and the second hinge plate and spaced apart from the plate.

According to an embodiment of the disclosure, the plate may move together with the first rack gear 330 and the second rack gear 340 that move along the guide 360.

According to an embodiment of the disclosure, while a state of the flexible electronic device 101 changes to an unfolded state in which the front surface of the first housing 110 and the front surface of the second housing 120 face the same direction, a bending area of the flexible display disposed on the plate may sag toward the plate.

According to an embodiment of the disclosure, the plate may be configured to maintain spacing from the bending area of the flexible display by moving together with the first rack gear 330 engaged with the first gear 311 and the second rack gear 340 engaged with the second gear 321.

According to an embodiment of the disclosure, the guide 360 may include a groove recessed from a surface of the guide 360 facing the first rack gear 330 and the second rack gear 340.

According to an embodiment of the disclosure, the first rack gear 330 and the second rack gear 340 may include a rod inserted into the groove.

According to an embodiment of the disclosure, the groove may be configured to limit movement in a second direction different from a first direction while the first rack gear and the second rack gear move in the first direction along the guide 360, by including a polygonal shape.

According to an embodiment of the disclosure, a foldable electronic device (e.g., the foldable electronic device 101 of FIG. 3B) may comprise a first housing (e.g., the first housing 110 of FIG. 3B), a second housing (e.g., the second housing 120 of FIG. 3B), and a hinge assembly (e.g., the hinge assembly 162 of FIG. 3B).

According to an embodiment of the disclosure, the hinge assembly 162 may rotatably couple the first housing 110 and the second housing 120.

According to an embodiment of the disclosure, the hinge assembly 162 may include a first rotator 310 connected to the first housing 110 and including a first gear 311 configured to rotate about a first axis a1, a second rotator 320 connected to the second housing 120 and including a second gear 321 configured to rotate about a second axis parallel to the first axis a1, a first rack gear 330 engaged with the first gear 311, a second rack gear 340 engaged with the second gear 321, and an elastic member 350 disposed between the first rack gear 330 and the second rack gear 340 and configured to maintain an angle between the first housing 110 and the second housing 120 by closely contacting the first gear 311 and the first rack gear 330 and closely contacting the second gear 321 and the second rack gear.

According to an embodiment of the disclosure, the first rack gear 330 and the second rack gear 340 may be configured to move linearly in accordance with a rotation of the first gear 311 and the second gear 321.

According to an embodiment of the disclosure, the foldable electronic device 101 may further comprise a guide (e.g., the guide 360 of FIG. 3B) extending along a movement direction of the first rack gear 330 and the second rack gear 340.

According to an embodiment of the disclosure, the first rack gear 330 and the second rack gear 340 may be movably coupled to the guide 360.

According to an embodiment of the disclosure, the first rack gear 330 may include a first structure accommodating a portion of the guide 360.

According to an embodiment of the disclosure, the second rack gear 340 may include a second structure accommodating another portion of the guide 360.

A cross-section of the guide 360 may have a shape in which widths of both end portions are wider than a width of another portion.

The foldable electronic device 101 may further comprise a hinge cover 165 surrounding the hinge assembly 162.

The first rotator 310 may include a first arm moving together with the first gear 311, and a first neck disposed between the first gear 311 and the first arm.

The second rotator 320 may include a second arm moving together with the second gear 321, and a second neck disposed between the second gear 321 and the second arm.

In an unfolded state in which a front surface of the first housing 110 and front surface of the second housing 120 face the same direction, the first neck may be configured to limit a rotation of the first rotator 310 by contacting the hinge cover 165.

The second neck may be configured to limit a rotation of the second rotator 320 by contacting the hinge cover 165.

The hinge assembly 162 may include a third rotator spaced apart from the first rotator 310 in a direction of the first axis a1 and configured to rotate about a third axis parallel to the first axis a1, a fourth rotator spaced apart from the second rotator 320 in a direction of the second axis a2 and configured to rotate about a fourth axis parallel to the second axis a2, and a frame 431 supporting the first rotator 310, the second rotator 320, the third rotator, and the fourth rotator, and including a guide groove to which a portion of the third rotator and a portion of the fourth rotator are rotatably coupled.

The first rotator 310 and the third rotator may be coupled to the first housing 110.

The second rotator 320 and the fourth rotator may be coupled to the second housing 120.

According to an embodiment of the disclosure, in a folded state in which the front surface of the first housing 110 and the front surface of the second housing 120 face each other, a portion of the second rotator 320 may be configured to limit a rotation of the first housing 110 by contacting a first stopper of the frame 431.

According to an embodiment of the disclosure, in the folded state in which the front surface of the first housing 110 and the front surface of the second housing 120 face each other, a portion of the fourth rotator may be configured to limit a rotation of the second housing 120 by contacting a second stopper of the frame 431.

The effects obtainable from the disclosure are not limited to those mentioned above, and other effects not mentioned herein may be clearly understood by those of ordinary skill in the art to which the disclosure belongs.

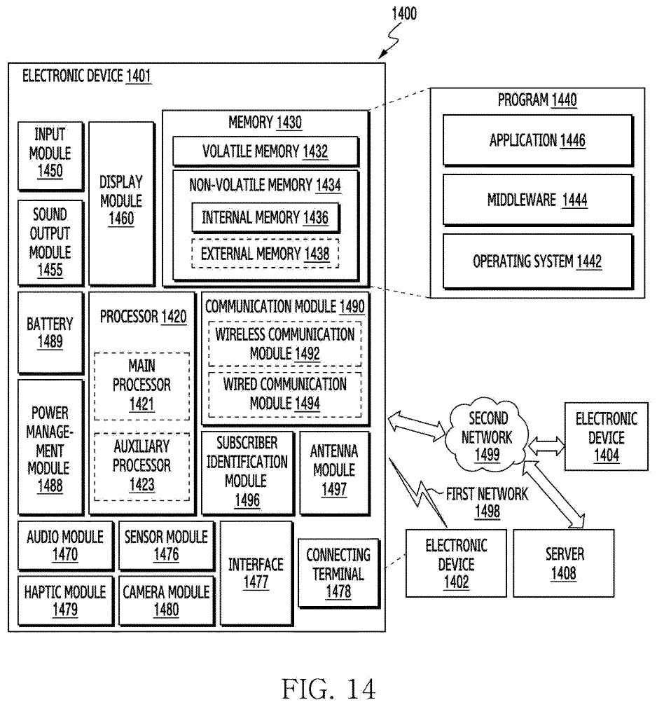

FIG. 14 is a block diagram illustrating an electronic device in a network environment according to an embodiment of the disclosure.

Referring to FIG. 14, an electronic device 1401 in a network environment 1400 may communicate with an external electronic device 1402 via a first network 1498 (e.g., a short-range wireless communication network), or at least one of an external electronic device 1404 or a server 1408 via a second network 1499 (e.g., a long-range wireless communication network). According to an embodiment of the disclosure, the electronic device 1401 may communicate with the external electronic device 1404 via the server 1408. According to an embodiment of the disclosure, the electronic device 1401 may include a processor 1420, memory 1430, an input module 1450, a sound output module 1455, a display module 1460, an audio module 1470, a sensor module 1476, an interface 1477, a connecting terminal 1478, a haptic module 1479, a camera module 1480, a power management module 1488, a battery 1489, a communication module 1490, a subscriber identification module (SIM) 1496, or an antenna module 1497. In some embodiments of the disclosure, at least one of the components (e.g., the connecting terminal 1478) may be omitted from the electronic device 1401, or one or more other components may be added in the electronic device 1401. In some embodiments of the disclosure, some of the components (e.g., the sensor module 1476, the camera module 1480, or the antenna module 1497) may be implemented as a single component (e.g., the display module 1460).

The processor 1420 may execute, for example, software (e.g., a program 1440) to control at least one other component (e.g., a hardware or software component) of the electronic device 1401 coupled with the processor 1420, and may perform various data processing or computation. According to an embodiment of the disclosure, as at least part of the data processing or computation, the processor 1420 may store a command or data received from another component (e.g., the sensor module 1476 or the communication module 1490) in volatile memory 1432, process the command or the data stored in the volatile memory 1432, and store resulting data in non-volatile memory 1434. According to an embodiment of the disclosure, the processor 1420 may include a main processor 1421 (e.g., a central processing unit (CPU) or an application processor (AP)), or an auxiliary processor 1423 (e.g., a graphics processing unit (GPU), a neural processing unit (NPU), an image signal processor (ISP), a sensor hub processor, or a communication processor (CP)) that is operable independently from, or in conjunction with, the main processor 1421. For example, when the electronic device 1401 includes the main processor 1421 and the auxiliary processor 1423, the auxiliary processor 1423 may be adapted to consume less power than the main processor 1421, or to be specific to a specified function. The auxiliary processor 1423 may be implemented as separate from, or as part of the main processor 1421.

The auxiliary processor 1423 may control at least some of functions or states related to at least one component (e.g., the display module 1460, the sensor module 1476, or the communication module 1490) among the components of the electronic device 1401, instead of the main processor 1421 while the main processor 1421 is in an inactive (e.g., sleep) state, or together with the main processor 1421 while the main processor 1421 is in an active state (e.g., executing an application). According to an embodiment of the disclosure, the auxiliary processor 1423 (e.g., an image signal processor or a communication processor) may be implemented as part of another component (e.g., the camera module 1480 or the communication module 1490) functionally related to the auxiliary processor 1423. According to an embodiment of the disclosure, the auxiliary processor 1423 (e.g., the neural processing unit) may include a hardware structure specified for artificial intelligence model processing. An artificial intelligence model may be generated by machine learning. Such learning may be performed, e.g., by the electronic device 1401 where the artificial intelligence is performed or via a separate server (e.g., the server 1408). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1430 may store various data used by at least one component (e.g., the processor 1420 or the sensor module 1476) of the electronic device 1401. The various data may include, for example, software (e.g., the program 1440) and input data or output data for a command related thereto. The memory 1430 may include the volatile memory 1432 or the non-volatile memory 1434.

The program 1440 may be stored in the memory 1430 as software, and may include, for example, an operating system (OS) 1442, middleware 1444, or an application 1446.

The input module 1450 may receive a command or data to be used by another component (e.g., the processor 1420) of the electronic device 1401, from the outside (e.g., a user) of the electronic device 1401. The input module 1450 may include, for example, a microphone, a mouse, a keyboard, a key (e.g., a button), or a digital pen (e.g., a stylus pen).

The sound output module 1455 may output sound signals to the outside of the electronic device 1401. The sound output module 1455 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 1460 may visually provide information to the outside (e.g., a user) of the electronic device 1401. The display module 1460 may include, for example, a display, a hologram device, or a projector and control circuitry to control a corresponding one of the display, hologram device, and projector. According to an embodiment of the disclosure, the display module 1460 may include a touch sensor adapted to detect a touch, or a pressure sensor adapted to measure the intensity of force incurred by the touch.

The audio module 1470 may convert a sound into an electrical signal and vice versa. According to an embodiment of the disclosure, the audio module 1470 may obtain the sound via the input module 1450, or output the sound via the sound output module 1455 or a headphone of an external electronic device (e.g., the external electronic device 1402) directly (e.g., wiredly) or wirelessly coupled with the electronic device 1401.

The sensor module 1476 may detect an operational state (e.g., power or temperature) of the electronic device 1401 or an environmental state (e.g., a state of a user) external to the electronic device 1401, and then generate an electrical signal or data value corresponding to the detected state. According to an embodiment of the disclosure, the sensor module 1476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1477 may support one or more specified protocols to be used for the electronic device 1401 to be coupled with the external electronic device (e.g., the external electronic device 1402) directly (e.g., wiredly) or wirelessly. According to an embodiment of the disclosure, the interface 1477 may include, for example, a high definition multimedia interface (HDMI), a universal serial bus (USB) interface, a secure digital (SD) card interface, or an audio interface.

A connecting terminal 1478 may include a connector via which the electronic device 1401 may be physically connected with the external electronic device (e.g., the external electronic device 1402). According to an embodiment of the disclosure, the connecting terminal 1478 may include, for example, an HDMI connector, a USB connector, an SD card connector, or an audio connector (e.g., a headphone connector).

The haptic module 1479 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 1479 may include, for example, a motor, a piezoelectric element, or an electric stimulator.

The camera module 1480 may capture a still image or moving images. According to an embodiment of the disclosure, the camera module 1480 may include one or more lenses, image sensors, image signal processors, or flashes.

The power management module 1488 may manage power supplied to the electronic device 1401. According to an embodiment of the disclosure, the power management module 1488 may be implemented as at least part of, for example, a power management integrated circuit (PMIC).

The battery 1489 may supply power to at least one component of the electronic device 1401. According to an embodiment of the disclosure, the battery 1489 may include, for example, a primary cell which is not rechargeable, a secondary cell which is rechargeable, or a fuel cell.

The communication module 1490 may support establishing a direct (e.g., wired) communication channel or a wireless communication channel between the electronic device 1401 and the external electronic device (e.g., the external electronic device 1402, the external electronic device 1404, or the server 1408) and performing communication via the established communication channel. The communication module 1490 may include one or more communication processors that are operable independently from the processor 1420 (e.g., the application processor (AP)) and supports a direct (e.g., wired) communication or a wireless communication. According to an embodiment of the disclosure, the communication module 1490 may include a wireless communication module 1492 (e.g., a cellular communication module, a short-range wireless communication module, or a global navigation satellite system (GNSS) communication module) or a wired communication module 1494 (e.g., a local area network (LAN) communication module or a power line communication (PLC) module). A corresponding one of these communication modules may communicate with the external electronic device via the first network 1498 (e.g., a short-range communication network, such as Bluetooth™, wireless-fidelity (Wi-Fi) direct, or infrared data association (IrDA)) or the second network 1499 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1492 may identify and authenticate the electronic device 1401 in a communication network, such as the first network 1498 or the second network 1499, using subscriber information (e.g., international mobile subscriber identity (IMSI)) stored in the subscriber identification module 1496.

The wireless communication module 1492 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1492 may support a high-frequency band (e.g., the millimeter wave (mmWave) band) to achieve, e.g., a high data transmission rate. The wireless communication module 1492 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1492 may support various requirements specified in the electronic device 1401, an external electronic device (e.g., the external electronic device 1404), or a network system (e.g., the second network 1499). According to an embodiment of the disclosure, the wireless communication module 1492 may support a peak data rate (e.g., 20 Gbps or more) for implementing eMBB, loss coverage (e.g., 1464 dB or less) for implementing mMTC, or user plane (U-plane) latency (e.g., 0.5 ms or less for each of downlink (DL) and uplink (UL), or a round trip of 14 ms or less) for implementing URLLC.

The antenna module 1497 may transmit or receive a signal or power to or from the outside (e.g., the external electronic device) of the electronic device 1401. According to an embodiment of the disclosure, the antenna module 1497 may include an antenna including a radiating element including a conductive material or a conductive pattern formed in or on a substrate (e.g., a printed circuit board (PCB)). According to an embodiment of the disclosure, the antenna module 1497 may include a plurality of antennas (e.g., array antennas). In such a case, at least one antenna appropriate for a communication scheme used in the communication network, such as the first network 1498 or the second network 1499, may be selected, for example, by the communication module 1490 (e.g., the wireless communication module 1492) from the plurality of antennas. The signal or the power may then be transmitted or received between the communication module 1490 and the external electronic device via the selected at least one antenna. According to an embodiment of the disclosure, another component (e.g., a radio frequency integrated circuit (RFIC)) other than the radiating element may be additionally formed as part of the antenna module 1497.

According to various embodiments of the disclosure, the antenna module 1497 may form a mmWave antenna module. According to an embodiment of the disclosure, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 1401 and the external electronic device 1404 via the server 1408 coupled with the second network 1499. Each of the external electronic devices 1402 or 1404 may be a device of a same type as, or a different type, from the electronic device 1401. According to an embodiment of the disclosure, all or some of operations to be executed at the electronic device 1401 may be executed at one or more of the external electronic devices 1402 or 1404, or the server 1408. For example, if the electronic device 1401 should perform a function or a service automatically, or in response to a request from a user or another device, the electronic device 1401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1401. The electronic device 1401 may provide the outcome, with or without further processing of the outcome, as at least part of a reply to the request. To that end, a cloud computing, distributed computing, mobile edge computing (MEC), or client-server computing technology may be used, for example. The electronic device 1401 may provide ultra low-latency services using, e.g., distributed computing or mobile edge computing. In another embodiment of the disclosure, the external electronic device 1404 may include an Internet-of-things (IoT) device. The server 1408 may be an intelligent server using machine learning and/or a neural network. According to an embodiment of the disclosure, the external electronic device 1404 or the server 1408 may be included in the second network 1499. The electronic device 1401 may be applied to intelligent services (e.g., a smart home, a smart city, a smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 1440) including one or more instructions that are stored in a storage medium (e.g., internal memory 1436 or external memory 1438) that is readable by a machine (e.g., the electronic device 1401). For example, a processor (e.g., the processor 1420) of the machine (e.g., the electronic device 1401) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

No claim element is to be construed under the provisions of 35 U.S.C. § 112, sixth paragraph, unless the element is expressly recited using the phrase “means for” or “means.”

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

No claim element is to be construed under the provisions of 35 U.S.C. § 112, sixth paragraph, unless the element is expressly recited using the phrase “means for” or “means.”

What is claimed is:

1. A foldable electronic device comprising:
a first housing;
a second housing; and
a hinge assembly rotatably connecting the first housing and the second housing, the hinge assembly comprising:
a first rotator, including a first gear configured to rotate about a first axis, connecting to the first housing;
a second rotator, including a second gear configured to rotate about a second axis parallel to the first axis, connecting to the second housing;
a first rack gear engaged with the first gear;
a second rack gear engaged with the second gear;
an elastic member, disposed between the first rack gear and the second rack gear, configured to press the first rack gear and the second rack gear in a direction toward the first gear and the second gear, respectively; and
a guide guiding movement of the first rack gear and the second rack gear in accordance with a rotation of the first gear and the second gear.

2. The foldable electronic device of claim 1,
wherein the guide extends along a movement direction of the first rack gear and the second rack gear, and
wherein the first rack gear and the second rack gear are movably coupled to the guide.

3. The foldable electronic device of claim 1,
wherein the first rack gear comprises a first structure accommodating a portion of the guide, and
wherein the second rack gear comprises a second structure accommodating another portion of the guide.

4. The foldable electronic device of claim 3, wherein the first structure is configured to surround a lateral side of the guide with the second structure.

5. The foldable electronic device of claim 1, wherein a cross-section of the guide has a shape in which widths of both ends are wider than a width of another portion.

6. The foldable electronic device of claim 1, wherein the hinge assembly comprises a frame in which the guide is disposed and which is configured to support the first rack gear and the second rack gear.

7. The foldable electronic device of claim 1,
wherein the first rotator comprises:
a first arm moving with the first gear; and
a first neck disposed between the first gear and the first arm, and
wherein the second rotator comprises:
a second arm moving together with the second gear, and
a second neck disposed between the second gear and the second arm.

8. The foldable electronic device of claim 7, further comprising a hinge cover surrounding the hinge assembly,
wherein the first neck is configured to limit a rotation of the first rotator by being contacted the hinge cover when the foldable electronic device is in an unfolded state, and
wherein the second neck is configured to limit a rotation of the second rotator by being contacted the hinge cover when the foldable electronic device is in the unfolded state.

9. The foldable electronic device of claim 1,
wherein the hinge assembly comprises:
a third rotator spaced apart from the first rotator in a direction of the first axis and configured to rotate about a third axis parallel to the first axis,
a fourth rotator spaced apart from the second rotator in a direction of the second axis and configured to rotate about a fourth axis parallel to the second axis, and
a frame supporting the first rotator, the second rotator, the third rotator, and the fourth rotator, and including a guide groove to which a portion of the third rotator and a portion of the fourth rotator are rotatably coupled,
wherein the first rotator and the third rotator are coupled to the first housing, and
wherein the second rotator and the fourth rotator are coupled to the second housing.

10. The foldable electronic device of claim 9,
wherein a portion of the second rotator is configured to limit a rotation of the first housing by contacting a first stopper of the frame when the foldable electronic device is in a folded state, and
wherein a portion of the fourth rotator is configured to limit a rotation of the second housing by contacting a second stopper of the frame when the foldable electronic device is in the folded state.

11. The foldable electronic device of claim 1, further comprising:
a first hinge plate coupled to the first rotator;
a second hinge plate coupled to the second rotator;
a plate disposed between the first rotator and the second rotator and coupled to the first rack gear and the second rack gear; and
a flexible display supported by the first hinge plate and the second hinge plate and spaced apart from the plate.

12. The foldable electronic device of claim 11, wherein the plate is moved with the first rack gear and the second rack gear which are moved along the guide.

13. The foldable electronic device of claim 11,
wherein a bending area of the flexible display disposed on the plate is configured to sag toward the plate while a state of the foldable electronic device changes from a folded state of the foldable electronic device to an unfolded state of the foldable electronic device, and
wherein the plate is spaced apart from the bending area of the flexible display by moving the first rack gear engaged with the first gear and the second rack gear engaged with the second gear while a state of the foldable electronic device changes from a folded state of the foldable electronic device to an unfolded state of the foldable electronic device.

14. The foldable electronic device of claim 1,
wherein the guide comprises a groove recessed from a surface of the guide facing the first rack gear and the second rack gear, and
wherein the first rack gear and the second rack gear comprises a rod inserted into the groove.

15. The foldable electronic device of claim 14, wherein the groove is configured to limit a moment in a second direction different from a first direction by including a polygonal shape while the first rack gear and the second rack gear move according to the guide.

16. A foldable electronic device comprising:
a first housing part;
a second housing part; and
a hinge assembly rotatably connecting the first housing part and the second housing part, the hinge assembly including:
a first rotator, including a first gear configured to rotate about a first axis, connecting to the first housing part,
a second rotator, including a second gear configured to rotate about a second axis parallel to the first axis, connecting to the second housing part,
a first rack gear engaged with the first gear,
a second rack gear engaged with the second gear, and
an elastic member, disposed between the first rack gear and the second rack gear closely contacting the first gear and the first rack gear, and configured to maintain an angle between the first housing part and the second housing part by closely contacting the second gear and the second rack gear,
wherein the first rack gear and the second rack gear are configured to linearly move by a rotation of the first gear and the second gear.

17. The foldable electronic device of claim 16, further comprising a guide extending along a movement direction of the first rack gear and the second rack gear,
wherein the first rack gear and the second rack gear is movably coupled to the guide,
wherein the first rack gear comprises a first structure accommodating a portion of the guide, and
wherein the second rack gear comprises a second structure accommodating another portion of the guide.

18. The foldable electronic device of claim 17, wherein a cross-section of the guide has a shape in which widths of both ends are wider than a width of another portion.

19. The foldable electronic device of claim 16, further comprising a hinge cover surrounding the hinge assembly,
wherein the first rotator comprises:
a first arm moving with the first gear, and
a first neck disposed between the first gear and the first arm,
wherein the second rotator comprises:
a second arm moving together with the second gear, and
a second neck disposed between the second gear and the second arm,
wherein the first neck is configured to limit a rotation of the first rotator by being contacted the hinge cover when the foldable electronic device is in an unfolded state, and
wherein the second neck is configured to limit a rotation of the second rotator by being contacted the hinge cover when the foldable electronic device is in the unfolded state.

20. The foldable electronic device of claim 16,
wherein the hinge assembly comprises:
a third rotator spaced apart from the first rotator in a direction of the first axis and configured to rotate about a third axis parallel to the first axis,
a fourth rotator spaced apart from the second rotator in a direction of the second axis and configured to rotate about a fourth axis parallel to the second axis, and
a frame supporting the first rotator, the second rotator, the third rotator, and the fourth rotator, and comprising a guide groove to which a portion of the third rotator and a portion of the fourth rotator are rotatably coupled,
wherein the first rotator and the third rotator are coupled to the first housing part, and
wherein the second rotator and the fourth rotator are coupled to the second housing part.
